(19) United States
(12) Patent Application Publication
(10) Pub. No.: US 2018/0172576 A1
(43) Pub. Date: Jun. 21, 2018

(54) METHODS AND APPARATUS FOR CONDUCTING PARTICLE EROSION TESTS OF VEHICLE SURFACES

(71) Applicant: The Boeing Company, Chicago, IL (US)

(72) Inventors: Kenneth Walter Young, Bear, DE (US); Kondala R. Saripalli, Town and Country, MO (US); Mark B. Younger, St. Charles, MO (US)

(21) Appl. No.: 15/381,641

(22) Filed: Dec. 16, 2016

(51) Int. Cl. G01N 17/00

(52) U.S. Cl. CPC G01N 17/002

(57) ABSTRACT

Methods and apparatus for conducting particle erosion tests of vehicle surfaces are disclosed. An example apparatus includes a particle dispersion chamber. The particle dispersion chamber includes a first end and a second end opposite the first end. The example apparatus includes an air supply feed coupled to the first end to provide air flow to the dispersion chamber. The example apparatus includes a first nozzle adjacent the second end. The example apparatus includes an injector extending into the particle dispersion chamber. The injector is to inject particles into the air flow to generate a particle-injected air stream. The first nozzle is to deliver the particle-injected air stream to a test chamber coupled to the first nozzle.

### FIELD OF THE DISCLOSURE

This disclosure relates generally to particle erosion tests and, more particularly, to methods and apparatus for conducting particle erosion tests of vehicle surfaces.

### BACKGROUND

A vehicle such as an aircraft may be exposed to environmental conditions that can lead to surface erosion, structural damage, and/or loss of performance of one or more components of the aircraft. For example, a rotorcraft can be exposed to an environment including sand, gravel, dust, and/or other particles that impact blade surfaces of the rotorcraft during flight and contribute to erosion or wear of the blades over time. Materials such as protective coatings can be applied to the surface of the rotor blades in an effort to reduce erosive effects of the environment on the blades. Also, structural shielding components can be installed on or integrated into the rotor blades to provide protection from erosive effects.

### SUMMARY

An example apparatus includes a particle dispersion chamber. The particle dispersion chamber includes a first end and a second end opposite the first end. The example apparatus includes an air supply feed coupled to the first end to provide air flow to the dispersion chamber. The example apparatus includes a first nozzle adjacent the second end. The example apparatus includes an injector extending into the particle dispersion chamber. The injector is to inject particles into the air flow to generate a particle-injected air stream. The first nozzle is to deliver the particle-injected air stream to a test chamber coupled to the first nozzle.

Another example apparatus includes a test chamber. The test chamber includes a first end and a second end opposite the first end. The example apparatus includes a nozzle having an elliptical cross-section coupled to the first end. The example apparatus includes an outlet at the second end. The example apparatus includes a rack disposed in the test chamber between the first end and the second end to position a test sample between the nozzle and the outlet. The nozzle is to deliver an air flow including solid particles to the test chamber to expose the test sample to the air flow.

Yet another example apparatus includes a particle dispersion chamber and test chamber. The example apparatus includes means for providing air to the particle dispersion chamber. The example apparatus includes means for injecting particles into the particle dispersion chamber. The example apparatus includes means for accelerating the particles relative to the air flow. The means for accelerating is to deliver an air stream including the particles to means for testing a test sample.

### BRIEF DESCRIPTION OF THE DRAWINGS

FIG. 1 is a schematic illustration of an example environment including an example vehicle.

FIG. 2 is a schematic illustration of an example system for conducting erosion tests in accordance with the teaching disclosed herein.

FIG. 3 is a schematic illustration of an example pressure control system of the example system of FIG. 2.

FIGS. 4 and 5 are top cross-sectional views of an example dispersion chamber and dispersion nozzle of the example system of FIG. 2 taken along the 1-1 line of FIG. 2.

FIG. 6 is a schematic illustration of the example dispersion nozzle of FIGS. 4 and 5.

FIG. 7 is a schematic illustration of an example erosion pattern generated by the example system of FIG. 2.

FIG. 8 is a schematic illustration of a test chamber of the example system of FIG. 2.

FIG. 9 is a top cross-sectional view of the example test chamber of FIG. 8 including a test sample disposed therein taken along the 2-2 line of FIG. 8.

FIG. 10 is a schematic illustration of the example test chamber of FIGS. 8 and 9 including a test sample disposed therein.

FIG. 11 is a flow diagram of an example method for generating a particle-injected air stream that may be implemented by the example system of FIG. 2.

FIG. 12 is a flow diagram of an example method to perform an erosion test that may be implemented by the example system of FIG. 2.

FIG. 13 is a diagram of a processor platform that may be used to carry out the example methods of FIGS. 11 and 12 and/or, more generally, to implement the example system of FIG. 2.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. Also, any dimensions or measurements referenced in the written description are for example purposes only and do not limit the disclosure to the example dimensions or measurements or ranges of the example dimensions or measurements referenced herein.

### DETAILED DESCRIPTION

A vehicle such as an aircraft (e.g., a plane, a rotorcraft) includes one or more surface components that are exposed to the environment in which the aircraft is traveling. For example, a rotor blade of a helicopter can be exposed to weather such as rain, snow, and ice in addition to solid particles such as a sand, gravel, debris, dust, etc. that can impact a surface of the blade while the helicopter is in flight. Over time, the repeated exposure of the blade to particles in the environment such as sand can accelerate erosion (including, but not limited to, wear, distortion, damage, failure, disbonding, etc.) of the blade. For example, erosion can cause damage to the leading and/or trailing edges of the blade and/or a tip of the blade, which can affect performance of the blade and compromise the structural integrity of the blade. Erosion can also damage other surfaces of the blade, such as a surface extending between the leading and trailing edges of the blade. Erosion damage can shorten blade life and require more frequent repair or replacement of the blade, which increases operational costs for the vehicle.

Efforts to reduce the effects of erosion on aircraft components such as a rotor blade include selecting erosion-resistant materials for at least a portion of a surface (e.g., skin) of the blade and/or applying one or more protective coatings or shielding materials (e.g., a polymer material, a ceramic material, metal) to at least a portion of the skin of the blade, such as at the leading edge and/or the trailing edge of the blade. However, testing the effectiveness of the erosion prevention measures (e.g., the protective coatings, design(s) of the structural shielding components(s)) is difficult with respect to accurately simulating an environment to which the blade is exposed during operation of the aircraft and which contributes to erosion of the blade.

Some known methods for conducting erosion testing include introducing high pressure air mixed with solid particles into a stagnant chamber (e.g., an abrasive blasting chamber) containing a test sample such as a blade specimen. In such known methods, the air flow is ejected via a nozzle and typically impinges only a portion of the test blade (e.g., based on a size of a diameter of the nozzle from which the air flow is ejected). Thus, in examples where the nozzle size is small, a pattern such as a raster pattern may be used to expose different portions of the test blade surface to the particles so as to expose the test surface (e.g., the whole surface, select portions thereof) to the particles. However, such testing is inefficient due longer test durations and higher costs. Also, in known methods, the particles (e.g., sand) in the air flow may travel at non-uniform speeds, may decelerate before reaching the test sample, exhibit unrepresentative interactions across the test sample relative to behavior in the environment, may not be entrained in air flow that is capable of substantially replicating air and particle flow behavior, may impinge the test sample at an angle that does not accurately represent the impingement angle in the environment, and/or may not be uniformly dispersed in the air flow. For example, the particles may decelerate because of a lack of continuity of flow to carry the particles. As the particles flow across the test sample, the particles impinge the test blade at decreasing speeds. As a result, erosion of the test sample decreases with increased sample distance from the nozzle where the particles are ejected. Therefore, test parameters and/or test results may be inconsistent between tests. Additionally, the chamber may not be able to accommodate a full size-blade. Thus, known methods employing blasting chambers do not create a realistic erosive environment to which the blade is exposed during operation.

Other known methods for conducting erosion testing include rotating a test sample such as a test blade via a whirling arm. Although the whirling arm may be able to achieve rotational speeds that simulate impact speeds of the particles in the environment, the size and shape of the test sample is limited by the structural capabilities of the whirling arm. Also, because whirling arms are typically smaller than, for example, full size rotor blades, faster rotational speeds may be used to achieve tangential speeds that are generated when the test blade is in operation. As a result, the exaggerated centrifugal forces applied radially to the test blade can exacerbate impact conditions of the particles on the test blade. Also, the test sample may be subject to recirculation effects and edge flow patterns that can alter erosion air flow patterns to which the test sample is exposed. Further, conditions in, for example, a room in which the whirling arm operates can affect air/particle interactions as a result of recirculation of the air flow. Also, in some examples, the particles can be subject to disintegration. Thus, testing using a whirling arm does not accurately replicate the environment in which the test sample operates and may not be representative of environments to which test samples such as fixed wings are exposed.

Example methods and apparatus disclosed herein provide for erosion testing of a vehicle surface such as a blade that simulates a substantially realistic aerodynamic flow field to which the surface is exposed during operation of the vehicle. Examples disclosed herein provide a high volume, low pressure air supply in which with solid particles (e.g., sand) are suspended and dispersed such that the particles are uniformly mixed with the air. Examples disclosed herein generate particle flow and impact conditions (e.g., particle size, speed, angle, uniformity distribution) that substantially mimic flow fields in environments in which the vehicle operates. In disclosed examples, the particle flow and impact conditions can be selectively adjusted to expose a test sample (e.g., a specimen or representation of a portion of, for example, an aircraft such as a blade, a quantity of a material, etc.) to different erosion patterns and/or erosion rates to replicate wear, damage, and/or failure of the test sample. Disclosed examples can be used to assess the effectiveness of structural shielding components and/or protective coatings, evaluate materials and/or design configurations of the test sample, appraise the structural integrity of a repair to the surface of interest, estimate life of the test sample based on designs or improvement thereto, etc.

In examples disclosed herein, a pressure control system controls the injection of the solid particles into an air stream to substantially uniformly disperse the particles in the air stream. A particle dispersion or stilling chamber allows the particles to mix with the air stream and to accelerate to match the speed of the air stream. In some of the disclosed examples, an elliptically shaped nozzle is coupled to the dispersion chamber that further facilitates substantially uniform distribution of the particles in the air stream. As a result, the air flow that exits the dispersion chamber more accurately simulates environmental conditions to which the test sample would be exposed in operation than known methods that target high pressure air streams on a portion of, for example, a blade.

Some disclosed examples provide a test chamber that allows the test sample to be orientated in different positions to adjust the manner in which the particles impact the test sample. In disclosed examples, the test chamber includes vents to allow ambient air to enter the test chamber to, for example, allow the air stream to flow around and behind the test sample as would occur in actual flight conditions. One or more monitoring or data collection instruments can be used to collect data during testing and/or analyze the results.

Some disclosed examples include a test chamber that is large enough to accommodate a full-sized rotor blade (or a rotor blade having a least one full-size dimension (e.g., a rotor blade having a full-size airfoil chord dimension but a less than full-sized span). As such, larger amounts of test data can be obtained per test as compared to testing methods that only expose a scaled sample to the air stream or use an apparatus (e.g., a whirling arm) that is not able to support full-size components. Thus, disclosed examples increase efficiency of the erosion tests and reduce testing time and costs. Further, the improved uniformity with respect to particle dispersion as compared to known erosion testing methods enables testing conditions to be replicated and test results to be repeatedly verified.

Although examples disclosed herein are discussed in the context of aircraft vehicles and components thereof such as wings, blades, engines and/or components of engines, etc., examples disclosed herein can be utilized in other applications. For example, disclosed examples can be used to conduct erosion tests on static surfaces such as a fuselage, a windshield, a radome, etc. Also, examples disclosed herein can be utilized for erosion testing of land vehicles and/or for other surfaces, such as buildings. Also, in others examples, at test sample can be exposed to particles selected to stimulate damage other than erosion, such as hail damage or paint removal (e.g., by exposing the test sample to carbon dioxide pellets). In other examples, particles such as water droplets or wet beads or pellets are used in addition to or as an alternative to solid particles for simulating, for example, water droplet impact on surface. As such, the discussion of solid particle erosion testing for aircraft vehicles is for illustrative purposes only and does not limit this disclosure to aircraft vehicles.

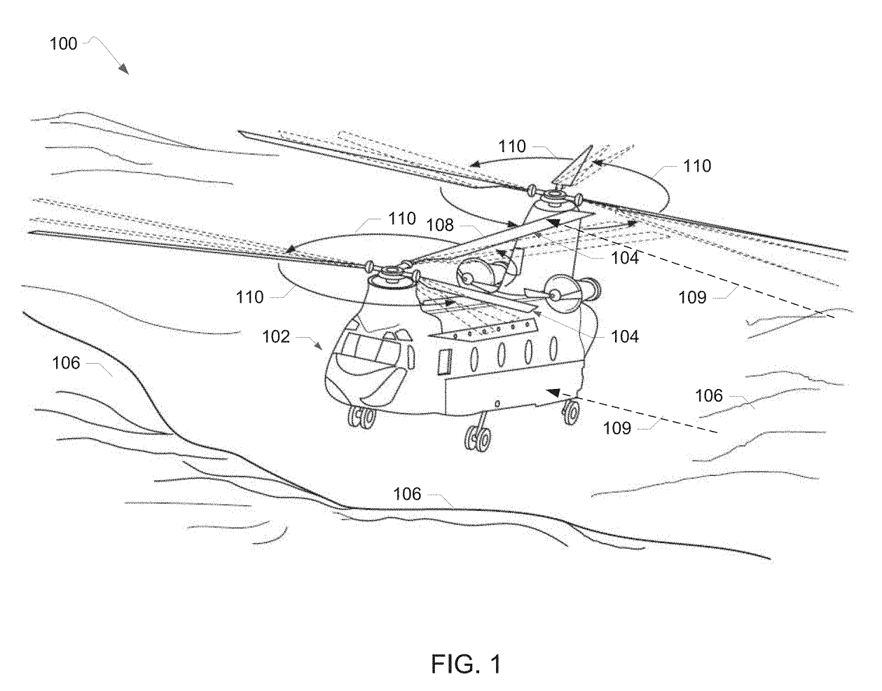

FIG. 1 is a schematic illustration of an example environment 100 including an example vehicle 102 exposed to the environment 100. As illustrated in FIG. 1, the example vehicle 102 is a rotorcraft having one or more blades 104. However, the vehicle 102 can include other types of aircraft, such as a plane having wings. As also illustrated in FIG. 1, the example environment 100 includes one or more solid particles 106 such as a sand or gravel that can mix with air and impinge upon or impact a surface 108 of the blade(s) 104 (as represented by the arrows 109 of FIG. 1) as the vehicle 102 flies through the environment 100 and the blade(s) 104 rotate (as represented by arrows 110 of FIG. 1). In other examples, the vehicle 102 and/or one or more surfaces thereof impact the solid particles 106.

The impact of the solid particles on the surface 108 of the blade(s) 104 can affect the performance and/or structural integrity of the blade(s) 104. For example, a leading edge, a trailing edge, and/or a tip of the blade(s) may erode due to exposure of the edges and/or tip to the solid particle-injected air flow, which can wear against the skin of the blade(s). In some examples, it may be desirable to test the blade(s) 104 to analyze the erosion behavior of the blade(s) 104 in response to exposure to air flow conditions that the blade(s) 104 may encounter in the environment 100. For example, tests may be conducted to analyze blade design, material(s) of which the blade(s) 104 are composed, and/or material(s) (e.g., coatings) applied to the blade(s) 104 to deter or reduce erosion of the blade(s) 104.

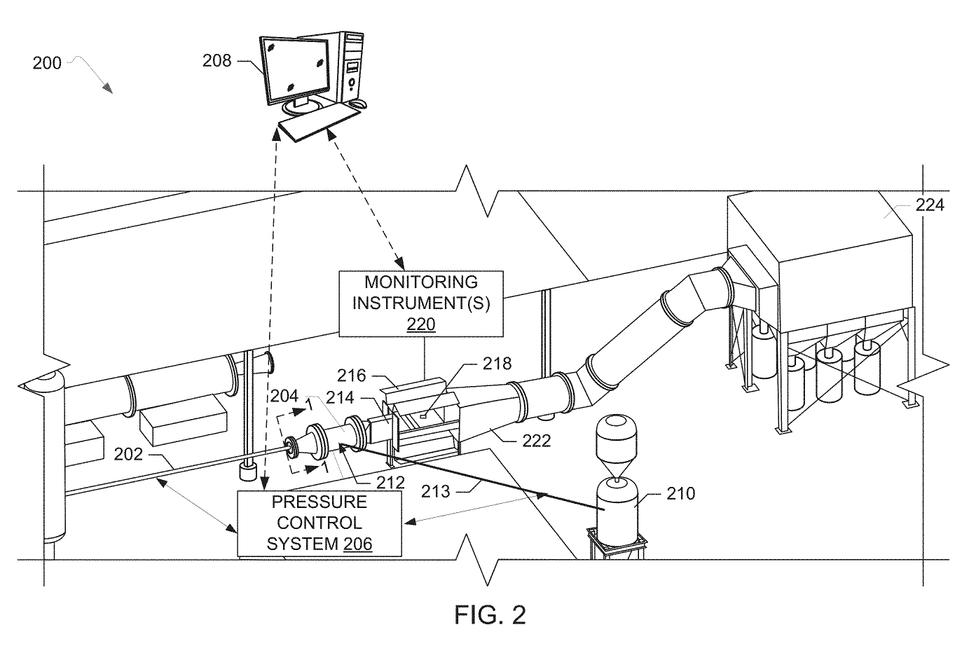

FIG. 2 is a schematic illustration of an example system 200 for conducting erosion testing on a surface, such as the blade(s) 104 of the example vehicle 102 of FIG. 1. The example system 200 can be used to, for example, substantially recreate an aerodynamic flow field to which the test surface may be exposed in an environment such as the environment 100 of FIG. 1. The example system 200 includes an air feed 202 to provide a flow of air for conducting the erosion tests. In the example system of FIG. 2, the air feed 202 provides a compressed air stream to a dispersion chamber 204 to which the air feed 202 is coupled. The example system 200 also includes a pressure control system 206 to control the output of air by the air feed 202. In the example system 200, the pressure control system 206 is communicatively coupled to a processor 208. The processor 208 provides instructions to the pressure control system 206, for example, control operation of the air feed 202 via one or more user inputs.

The dispersion chamber 204 of FIG. 2 also receives solid particles such as sand, plastic, aluminum oxide, etc. from one or more particle hoppers 210 that store the solid particles and which are operatively coupled to the dispersion chamber 204 via one or more injectors 212. The pressure control system 206 includes injector supply line(s) 213 (e.g., hoses) that supply the solid particles to the injector(s) 212 for delivery into the dispersion chamber 204. In the example system 200, the flow of solid particles from the particle hopper(s) 210 is controlled by the pressure control system 206. As will be disclosed below, the dispersion chamber 204 reduces a velocity of air from the air feed 202 to enable the solid particles from the particle hopper(s) 210 mix or substantially disperse with the air stream from the air feed 202 to generate a particle-injected air stream. Thus, the dispersion chamber 204 also serves as a stilling chamber with respect to the air from the air feed 202.

The air stream including the solid particles is ejected from the dispersion chamber 204 via a dispersion nozzle 214 of the dispersion chamber 204. In the example system 200, the dispersion nozzle 214 is coupled to a test chamber 216. One or more samples 218 (e.g., rotor blades, wings, etc.) that are to undergo erosion testing are disposed in the test chamber 216. In the example system 200, the particle-injected air stream is transmitted from the dispersion chamber 204 to the test chamber 216 via the dispersion nozzle 214. The particle-laden air stream flows over, around, and/or beneath the test sample(s) 218 disposed in the test chamber 216.

The example system 200 includes one or more monitoring instruments 220 to collect data during the erosion testing. The monitoring instrument(s) 220 can include, for example, cameras, sensors (e.g., pressure sensors), lasers, and/or other instruments to record data during the testing, such as particle exposure mass, particle velocity, particle-surface interaction, and/or to generate images of the test sample before, during and/or after testing. The monitoring instrument(s) 220 can be mechanically coupled an interior or an exterior of the test chamber 216. In the example system 200, one or more of the monitoring instruments 220 is communicatively coupled to the processor 208 (e.g., via a wireless connection). The processor 208 can, for example, store the data, analyze the test data, and/or output the data or analysis results derived from the data. In some examples, the processor 208 provides instructions to one or more of the monitoring instrument(s) 220 with respect to, for example, detecting a pressure level and/or positioning of a camera.

After the air stream flows through the test chamber 216, the air stream flows through a duct 222 coupled to the test chamber 216. The air flow travels through the duct 222 to a particle collection chamber 224, which collects and stores the particles from the air stream.

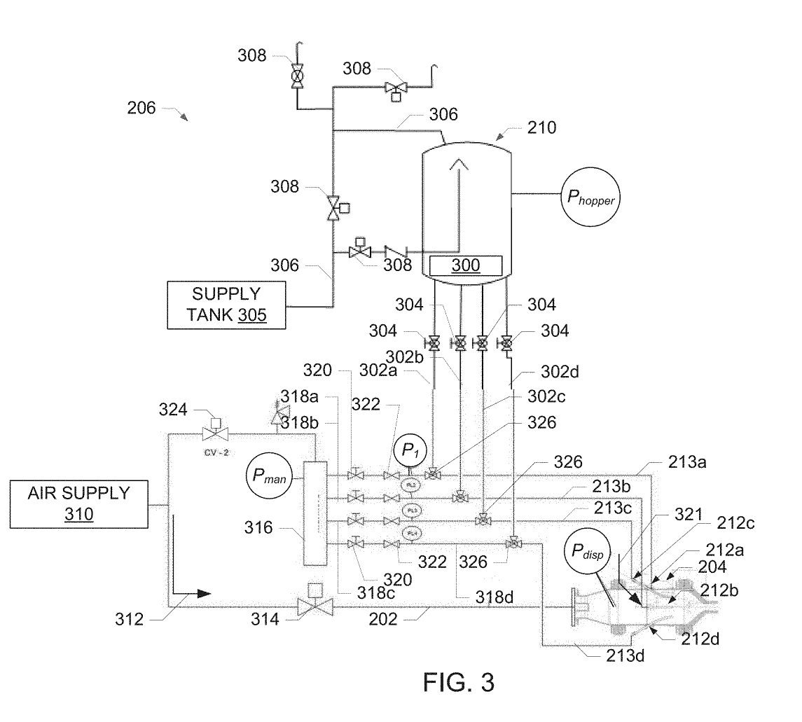

FIG. 3 is a schematic illustration of the example pressure control system 206 of the example system 200 of FIG. 2. As disclosed above, the example pressure control system 206 controls the flow of air from the air feed 202 into the dispersion chamber 204. Also, the example pressure control system 206 controls the flow of solid particles from the particle hopper(s) 210 to the dispersion chamber 204 for dispersion into the air stream that is flowing through the dispersion chamber 204 via the air feed 202. The pressure control system 206 can be controlled via one or more user inputs received via the example processor 208 of FIG. 2.

The example particle hopper 210 includes a plurality of solid particles 300 disposed in the particle hopper 210. The solid particles 300 can be selected based on a type of particle to which the test sample 218 is to be exposed. The solid particles 300 can be selected based on, for example, a size of the particles, a shape of the particles, etc. The solid particles 300 can include sand (e.g., quartz sand) aluminum oxide, plastic, gravel, etc.

As illustrated in FIG. 3, particle supply lines 302a, 302b, 302c, 302d are coupled to the particle hopper 210 to enable transmission of the solid particles 300 from the particle hopper 210 to the injector(s) 212 via the injector supply lines 213 for entry into the dispersion chamber 204. The example system 200 of FIGS. 2 and 3 includes a first injector 212a and a first injector supply line 213a, a second injector 212b and a second injector supply line 213b, a third injector 212c and a third injector supply line 213c, and a fourth injector 212d and a fourth injector supply line 213d. The example system 200 of FIGS. 2 and 3 can include additional or fewer injectors 212 and injector supply lines 213. The flow of the solid particles 300 from the particle hopper 210 to the injectors 212a-212d via the injector supply lines 213a-213d can be controlled via respective supply valves 304 of the particle supply lines 302.

The example pressure control system 206 includes a pressurized supply tank 305. The pressurized supply tank 305 supplies compressed dry air to the particle hopper 210 via one or more pressure supply lines 306 such that the particle hopper 210 has a pressure Pₕₒₚₚₑᵣ. The pressure of the particle hopper 210 can be regulated via one or more pressure supply valves 308 (e.g., solenoid valves) of the pressure supply lines 306.

The example pressure control system 206 includes an air supply 310. The air supply 310 can include a compressor air tank or a blower system. The air supply 310 provides a compressed air supply stream 312 (as represented by the corresponding arrow in FIG. 3). The compressed air supply stream 312 travels via the air feed 202 into the dispersion chamber 204. The example air feed 202 of FIG. 3 includes a control valve 314 to regulate a velocity of the air supply stream 312 entering the dispersion chamber 204. In some examples, a temperature of the air supply stream can be controlled to be colder or warmer than an ambient temperature to more accurately replicate, for example the environment 100 of FIG. 1 and/or to evaluate the effect of erosion of different test materials based on a thermal response.

The example pressure control system 206 provides for air flow control with respect to the injectors 212a-212d that deliver the solid particles 300 to the dispersion chamber 204. As illustrated in FIG. 3, air from the air supply 310 flows through a manifold 316. The manifold 316 ejects the air from the air supply 310 and the air travels into the respective injector supply lines 213a-213d via corresponding ejector supply lines 318a, 318b, 318c, 318d. In the example pressure control system 206, the flow of air into the injector supply lines 213a-213d can be controlled via respective ejector air shut off valves 320 associated with the ejector supply lines 318a-318d.

The ejector supply lines 318a-318d also include respective choke valves 322. An ejector air pressure control valve 324 controls a pressure of the air received at an inlet of each of the choke valves 322. In the example of FIG. 3, a pressure Pₘₐₙ at the manifold 316 is sufficiently high to allow the air to be choked by the choke valves 322. In the example of FIG. 3, the respective choke valves 322 can be selectively adjusted to provide a substantially constant air mass flow and to eliminate the effect of back pressure in the injector supply lines 213a-213d.

As illustrated in FIG. 3, air from the ejector supply lines 318a-318d and the solid particles 300 from the particle supply lines 302a-302d enter the injector supply lines 213a-213d via respective 3-way valves 326. In the example pressure control system 206, the flow rate of the solid particles 300 can be controlled via pressure differentials between the pressure of the air flowing through the respective ejector supply lines 318a-318d and the pressure Pₕₒₚₚₑᵣ of the particle hopper 210.

For example, the pressure difference between a pressure P₁ of the air in the ejector supply line 318a after passing through the choke valve 322 and the pressure Pₕₒₚₚₑᵣ of the particle hopper 210 can be adjusted to control a flow rate of the solid particles 300 through the first injector 212a coupled to the ejector supply line 318a via the first injector supply line 213a. In some examples, the pressure Pₕₒₚₚₑᵣ of the particle hopper 210 is greater than the pressure P₁ at the ejector supply line 318a (e.g., based on a position of the supply valves 304 of the particle supply line 302a). The choking of the choke valve 322 prevents back flow. In other examples, the valve 322 is an unchoked valve a pressure drop is used to prevent or substantially reduce back flow. In the example of FIG. 3, the choked air flow from the choke valve 322 of the ejector supply line 318a facilities a substantially uniform flow of the solid particles 300 and air between the first, second, third, and fourth injector supply lines 213a-213d. In the example pressure control system 206, flow rates of the solid particles 300 through the injectors 212a-212d can be independently controlled via the respective valves 304, 320, 322 of the particles supply lines 302a-302d and the ejector supply lines 318a-318d.

As illustrated in FIG. 3, the air supply stream 312 flowing through the air feed 202 enters the dispersion chamber 204. The dispersion chamber 204 serves as a stilling chamber and reduces a velocity of the air supply stream 312. Also, the solid particles 300 enter the dispersion chamber 204 via one or more of the injectors 212a-212d, as represented by an arrow 321 in FIG. 3. In the example of FIG. 3, the pressure at the injector(s) 212a-212d (e.g., P₁) is greater than a pressure P_{disp} of the dispersion chamber 204 to allow the solid particles 300 to gradually flow into the dispersion chamber 204 via the injectors 212a-212d. The reduced velocity of the air supply stream 312 facilitates mixing of the solid particles 300 with the air supply stream 312. The pressure differential between the pressure P_{disp} of the dispersion chamber 204 and the pressure at the injector(s) 212a-212d (e.g., P₁) can be used to control a rate at which the solid particles 300 are dispersed in the dispersion chamber 204. The velocity of the solid particles 300 exiting the injector(s) 212a-212d can be adjusted (e.g., via the processor 208) to facilitate substantially uniform mixing of the solid particles with the air supply stream 312. In the example of FIG. 3, momentum of the solid particles 300 exiting the injector(s) 212a-212d should be high enough to carry the solid particles to, for example, a center of dispersion chamber 204 for mixing with the air supply stream 312 but low enough such that the solid particles 300 do not, for example, exit from the injector(s) 212a-212d at speeds that cause them to, for example, blast a hole through the dispersion chamber 204 at a side of the dispersion chamber opposite an outlet of an injector. Thus, if a velocity of the solid particles 300 is too high or too low, the solid particles 300 may not uniformly disperse into the air supply stream 312 in the dispersion chamber 204. The pressure control system 206 regulates the feed of air and the solid particles 300 into the dispersion chamber 204 to enable generation of a substantially uniform mixed flow of air and the solid particles 300.

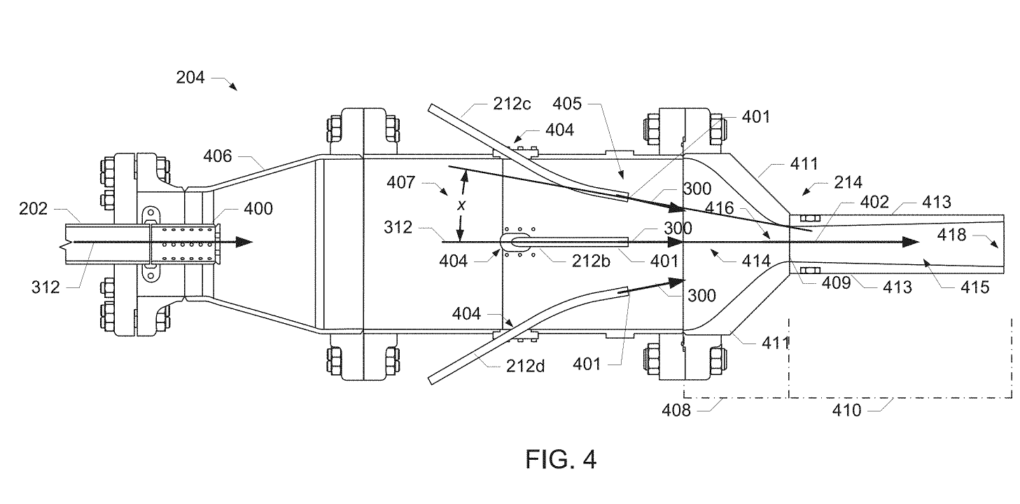

FIG. 4 is a top cross-sectional view of the example dispersion chamber 204 of the example system 200 of FIG. 2 taken along the 1-1 line of FIG. 2. A size and/or a shape of the dispersion chamber 204 can differ from the dispersion chamber 204 illustrated in FIG. 4. Also, an orientation of the dispersion chamber 204 can differ from the illustration in FIG. 4 with respect to whether the dispersion chamber 204 has a substantially vertical orientation (e.g., has a greater height than width) or a substantially horizontal orientation (e.g., has a greater width than height). As illustrated in FIG. 4, the air feed 202 includes a perforated air nozzle or flow distributor 400 that allows the air supply stream 312 of FIG. 3 to flow from the air feed 202 into the dispersion chamber 204. The perforated air nozzle 400 facilitates substantially uniform distribution of the air supply stream 312 in the dispersion chamber 204. The perforated air nozzle 400 allows the flow of the air supply stream 312 to expand more quickly in the dispersion chamber 204 as compared to a nozzle without perforations, thereby reducing a length of the dispersion chamber that is required to achieve uniform flow.

As disclosed above, the solid particles 300 enter the dispersion chamber 204 via one or more of the injectors 212a-212d and mix with the air supply stream 312 to form a particle-injected air stream 402 (as represented by the corresponding arrow of FIG. 4). In the example of FIG. 4, the particle-injected air stream 402 substantially simulates an aerodynamic flow field to which the test sample 218 of FIG. 2 may be exposed to in, for example, the environment 100 of FIG. 1.

Each of the injectors 212a-212d includes a nozzle 401 through which the solid particles 300 are emitted. In some examples, the nozzles 401 are substantially unobstructed openings. For example, the nozzle(s) 401 can include a substantially straight bore. In other examples, the nozzles(s) 401 include a venturi nozzle, a double venturi nozzle, etc. In other examples, the nozzles 401 of the injectors 212a-212d can include filter, perforations, etc. In some examples, a shape of the nozzle(s) 401 is selected based on desired particle exit characteristics. As illustrated in FIG. 4, each of the injectors 212b, 212c, 212d (including the respective nozzles 401) is at least partially disposed in an interior 405 of the dispersion chamber 204 via apertures 404 formed in walls 406 of the dispersion chamber 204. For example, the third injector 212c can be inserted on a left side of the dispersion chamber 204 relative to direction of travel of the air supply stream 312, the second injector 212b can be inserted in a top portion of the dispersion chamber 204, the fourth injector 212d can be inserted on a right side of the dispersion chamber 204. The first injector 212a (not shown in FIG. 4) can be inserted in a bottom portion of the dispersion chamber 204 (e.g., opposite the second injector 212b). The apertures 404 can be located in different positions relative to the walls 406 than illustrated in FIG. 4. As such, the injectors 212a-212d can be positioned in other locations relative to the walls 406 dispersion chamber 204. Although the first injector 212a is not shown in the cross-sectional view of FIG. 4, the first injector 212a will be discussed in connection with the other injectors 212b, 212c, 212d for completeness.

The injectors 212a-212d can be formed from, for example, steel and/or other materials having a sufficient strength such that the solid particles 300 do not damage the injectors 212a-212d as the solid particles 300 flow through the injectors 212a-212d. Material(s) of the injectors 212a-212d can be selected so as to substantially control and/or limit wear of the injectors 212a-212d over time to maintain injection functionality and/or particle injection conditions in the injectors 212a-212d, at the injector nozzles 401, etc. As illustrated in FIG. 4, the injectors 212c and 212d are slightly bent (e.g., to form an angle of at least 155 degrees). The bend in the injectors 212a-212d increases a length of the respective injectors 212a-212d that is within the dispersion chamber 204 as compared to if the injectors 212a-212d were straight. As such, a smaller sized dispersion chamber 204 can be used without reducing a length of the portion of the injectors 212a-212d in the chamber. A long dispersion chamber 204 extending past a location at which the solid particles 300 are injected into the chamber would adversely affect the substantially uniform distribution of the solid particles with the air supply stream 312. Thus, the bend in the injectors 212a-212d enables a more compact chamber to be used to better particle distribution. Also, the substantially small bend (e.g., 20 degrees) reduces damage to the injectors 212a-212d (e.g. due to material wear) by the particles as compared to a sharper bend. The angle at which the injectors 212a-212d can be selected based on, for example, a material of the injectors 212a-212d.

In the example of FIG. 4, each of the injectors 212a-212d is slidable via the apertures 404 with respect to a length of the injectors 212a-212d that is disposed in the interior 405 of the dispersion chamber 204. Put another way, the injectors 212a-212d can at least partially slide in and out of the dispersion chamber 204 via the apertures 404. The ability of the injectors 212a-212d to slide facilitates radial adjustment of the injectors 212a-212d relative to the dispersion chamber 204.

Also, in the example of FIG. 4, each of the injectors 212a-212d is positionable with respect to an angle 407 having a value of x at which the nozzles 401 of the injectors 212a-212d emit the solid particles 300 relative to the dispersion nozzle 214 of the dispersion chamber 204. The angle 407 of the injectors 212a-212d can be adjusted to have a value x of 0-15 degrees relative to the flow of the air supply stream 312. To adjust the angle 407 of one of the injectors 212a-212d, the selected injector can be removed from the aperture 404 of the dispersion chamber 204 and replaced with another injector having a bend angle that provides for the selected angle 407. In other examples, the selected injector is removed and re-inserted (or replaced with another injector) at a different aperture 404 in the dispersion chamber 204. The position of the injector with respect to the angle 407 can be fine-tuned by rotating the injector relative to the aperture 404. The angle 407 of the respective nozzles 401 of the injectors 212a-212d is selectively adjusted to adjust an angle at which the solid particles 300 are ejected from the injectors 212a-212d into the dispersion chamber 204. In some examples, each of the injectors 212a-212d is orientated at the same angle 407. In some examples, the injectors 212a-212d are manually positioned by a user. In other examples, the injectors 212a-212d are positioned by, for example, a robotic controller. Adjustment of the angle 407 of the injector(s) 212a-212d can also be based on respective bend angles of the injector(s) 212a-212d, injector length, and/or a location of the apertures 404 of the dispersion chamber 204. In some examples, design of the injectors 212a-212d, orientation of the injectors 212a-212d, etc. are based on design variations of the dispersion chamber 204 (e.g., a length of the chamber).

As disclosed above with respect to FIG. 2, the particle-injected air stream 402 exits the dispersion chamber 204 via the dispersion nozzle 214 and enters the test chamber 216. The example dispersion nozzle 214 includes a converging portion 408 and a diverging portion 410. A throat 409 is formed between the converging portion 408 and the diverging portion 410. The asymmetry of the dispersion nozzle 214 provides for different flow patterns of the particle-injected air stream 402. As will be disclosed below, the converging and diverging portions 408, 410 of the dispersion nozzle 214 accelerate the flow of the solid particles 300 and facilitate substantially uniform dispersion of the solid particles 300 in the air supply stream 312. As will also be disclosed below, the diverging portion 410 contributes to the creation of a desired erosion pattern at the test sample based on dispersion of the particle-injected air stream 402 at an outlet of the diverging portion 410 and concentrations of particle-injected air stream 402.

The dispersion nozzle 214 can include an entrance 414. In some examples, the entrance 414 has a substantially circular cross section such that a diameter of the entrance 414 is substantially equal to a diameter of the dispersion chamber 204. For example, a diameter of the dispersion chamber 204 can be 19 inches and a major axis of the entrance 414 can also be 19 inches. As illustrated in FIG. 4, the converging portion 408 is formed from the convergence of first sides 411 of the nozzle 214 at an angle (e.g., a 45 degree angle). As a result of the convergence of the first sides 411, a size of a minor cross-sectional axis of the converging portion 408 decreases over a length of the converging portion 408.

The diverging portion 410 of the example nozzle 214 of FIG. 4 has an elliptical cross-section formed from second sides 413 of the nozzle 214. In other examples, the diverging portion 410 has a cross-section with a shape derived from an ellipse (e.g., a circular cross-section). In other examples, the diverging portion 410 has a cross-section different than an ellipse or a derivation thereof. In the example of FIG. 4, the second sides 413 of the nozzle diverge along a length of the diverging portion 410 such that a contour 415 in the diverging portion 410 is substantially non-linear. For example, at least a portion of the second sides 413 of the diverging portion 410 can be substantially sloped, curved, etc. (e.g., such that a first portion of the contour is narrower than a second portion of the contour). The contour 415 of the divergence of the second side 413 diverging portion 410 can be formed based on, for example, a desired particle dispersion pattern (e.g., a wider dispersion pattern, a narrower dispersion pattern). For example, a minor cross-sectional axis of the dispersion nozzle 214 at a narrowest portion 416 of the converging portion 408 (e.g., immediately before the diverging portion 410 begins) can have a value of 4 inches and a minor cross-sectional axis of an opening 418 (e.g., an outlet) at the end of the diverging portion 410 opposite the narrowest portion 416 of the converging portion 408 can have a value of 5 inches. As disclosed below, the diverging portion 410 of the example nozzle 214 couples to the test chamber 216 and forms an inlet of the test chamber 216 for entry of particle-injected air stream 402.

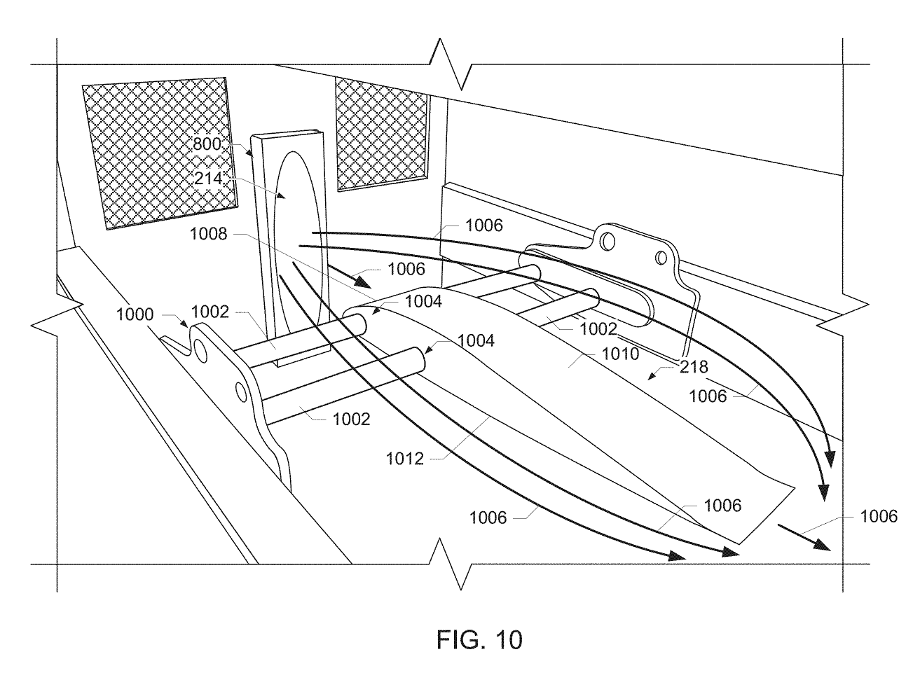

The converging and diverging portions 408, 410 of the dispersion nozzle 214 accelerate the flow of the particle-injected air stream 402. The converging and diverging portions 408, 410 of the example dispersion nozzle 214 enable the solid particles 300 to substantially uniformly disperse in the air supply stream 312 and facilitate a flow of the particle-injected air stream 402 at a desired flow rate. In the example of FIG. 4, adjustment of one or more of the following can affect the dispersion of the solid particles 300 and/or the flow rate of the air supply stream 312: a distance between the respective nozzles 401 of the injectors 212a-212d and the throat 409 of the dispersion nozzle 214 (e.g., 18 inches); an injection angle of the solid particles 300 based on, for example, rotation of the injectors 212a-212d and/or a geometry of the injectors 212a-212d; differential control of the respective injectors 212a-212d via the pressure control system 206 to independently control the flow rate of the solid particles 300 into the dispersion chamber 204; a length of the converging portion 408 of the dispersion nozzle 214 (e.g., 12 inches); a length of the diverging portion 410 of the dispersion nozzle 214 (e.g., 24 inches); a distance between end of the diverging portion 410 (which forms the inlet of the chamber 216) and the test sample 218 disposed in the test chamber 216 (as will be discussed in connection with FIG. 10, below); a contour geometry of the dispersion nozzle 214; and/or a velocity of the solid particles 300 from the dispersion nozzle 214. Other factors can affect the dispersion of the solid particles 300 and/or the flow rate of the air supply stream 312. In some examples, a size (e.g., a width), geometry, etc. of the dispersion nozzle 214 (and/or a size, geometry, etc. of any other components of the example system 200) are based on a dispersion pattern to be created via the particle-injected air stream 402. In some examples, the processor 208 is used to monitor the flow conditions in the dispersion chamber 204 and/or the test chamber 216 to generate the desired environment (e.g., the environment 100 of FIG. 1).

FIG. 5 illustrates example flow trajectories of the solid particles 300 of the particle-injected air stream 402 in the example dispersion chamber 204 based on differences with respect to the injection angle 407 at which the nozzles 401 of the injectors 212a-212d emit the solid particles 300. A flow trajectory can be represented as, for example, an average of a total flow from an injector 212a-212d to the opening 418 of the dispersion nozzle 214. FIG. 5 illustrates first example flow trajectories 504 of the solid particles 300 that are generated when the respective nozzles 401 of the third injector 212c and the fourth injector 212d are positioned such that the injection angle 407 has a value of, for example, 10 degrees. As shown in FIG. 5, the solid particles 300 emitted from the respective nozzles 401 of the third injector 212c and the fourth injector 212d enter the dispersion chamber 204, where the solid particles 300 mix with the air supply stream 312. As also shown in FIG. 5, the first example flow trajectories 504 of the solid particles 300 generated when the nozzles 401 are positioned at an injection angle of 10 degrees intersect at a first intersection point 506. The first example flow trajectories 504 can be based on, for example, geometries of the injectors 212a-212d, locations of the nozzles 401, geometry of the dispersion nozzle 214, flow properties of the air supply stream 312, the feed of the solid particles 300 into the dispersion chamber 204, etc. Different flow trajectories may be generated based on, for example, the erosion environment that is to be replicated, configuration of the test sample, etc.

FIG. 5 also illustrates second example flow trajectories 500 of the solid particles 300 that are generated when the respective nozzles 401 of the third injector 212c and the fourth injector 212d are positioned such that the injection angle 407 has a value of, for example, 5 degrees. As shown in FIG. 5, the second example flow trajectories 500 of the solid particles 300 generated when the nozzles 401 are positioned at an injection angle of 5 degrees intersect at a second intersection point 502.

As illustrated in FIG. 5, the value of the injection angle 407 affects the positions of the intersection points 506, 502 of the respective first and second flow trajectories 504, 500 as well as dispersion and concentration of the solid particles 300. For example, the first intersection point 506 of the first flow trajectories 504 when the injection angle has a value of 10 degrees is proximate to the converging portion 408 of the dispersion nozzle 214 and the second intersection point 502 of the second flow trajectories 500 when the injection angle has a value of 5 degrees is proximate to the diverging portion 410 of the dispersion nozzle 214. The position of the intersection point is dependent on both the injector angle and the location of the nozzles 401. The position of the intersection point affects, for example, an angle at which the flow trajectories 504, 500 flow through the diverging portion 410, as illustrated in FIG. 5. As disclosed below, the first and second flow trajectories 504, 500 of the solid particles 300 influence the formation of different erosive patterns formed by the particle-injected air stream 402.

Thus, when the solid particles 300 are emitted into the dispersion chamber 204, the solid particles 300 follow trajectories that facilitate dispersion and mixing of the solid particles 300 with the air supply stream 312. Rather than acting in a substantially ballistic manner when the solid particles 300 are emitted from the nozzles 401 by, for example, shooting through the dispersion chamber 204 in a straight line, the solid particles 300 disperse in the air supply stream 312 via the convergence of the air supply stream 312 as the air supply stream 312 flows through the converging portion 408 of the dispersion nozzle 214. The converging portion 408 of the dispersion nozzle 214 directs the flow trajectories of solid particles 300 to intersect with flow trajectories of other solid particles 300 in the dispersion chamber 204 and to mix with the air supply stream 312 to form the particle-injected air stream 402. In some examples, the solid particles exhibit at least some ballistic behavior to enable the solid particles to disperse with the air supply stream 312. The ballistic behavior of the solid particles 300 can be adjusted based on, for example, a trajectory of the air supply stream 312, streamline effects, etc. In some examples, the solid particles are substantially uniformly dispersed with the air supply stream 312 before the particle-injected air stream 402 enters the diverging portion 410 of the dispersion nozzle 214. The mixing of the solid particles 300 with the air supply stream 312 substantially reduces, for example, erosion of or other damage to the interior 405 of the dispersion chamber 204 and/or the dispersion nozzle 214 as compared to if the solid particles 300 acted substantially ballistically after being emitted from the nozzles 401 and directly impacted the interior 405 of the dispersion chamber 204.

In the example of FIGS. 3-5, the air supply stream 312 may have a different velocity than the solid particles 300 entering the dispersion chamber 204. For example, the velocity of the air supply stream 312 can be greater than the velocity of the solid particles 300 emitted from the nozzles 401 of the third and fourth injectors 212c, 212d. As the solid particles 300 are carried through the converging and diverging portions 408, 410 of the dispersion nozzle 214, the solid particles 300 are accelerated such that a velocity of the solid particles 300 substantially equalizes with a velocity of the air supply stream 312 (e.g., a Mach number of 0.2 to 0.9). For example, the gradual divergence of the second sides 413 of the nozzle 214 allows the velocity of the solid particles 300 to substantially equalize with the velocity of the air. Thus, solid particles 300 flow with the air without lag relative to the velocity of the air.

As illustrated in FIG. 5, the first and second flow trajectories 504, 500 deviate from a straight or ballistic flow trajectory 508. The solid particles 300 follow flow paths resulting from the diverging portion 410 of the dispersion nozzle 214 and/or preceding trajectories travelled by the particle-injected air streams through the dispersion nozzle 214. As a result, the particle-injected air stream 402 flows at a desired particle concentration and/or speed distribution prior to exiting the dispersion nozzle 214 such that the solid particles 300 are entrained with air flow. Thus, in some examples, the solid particles 300 do not act ballistically and fire directly at the test sample 218 when the particle-injected air stream 402 exits the dispersion nozzle 214. A direct firing of the solid particles 300 may not accurately reflect erosion patterns encountered by the test sample 218 in, for example, the environment 100 because the solid particles 300 are not substantially entrained in the air supply stream 312.

Rather, in some examples, the first and second flow trajectories 504, 500 provide for dispersion of the solid particles 300 that replicates one or more erosion patterns having shapes other than a straight line. For example as illustrated in FIG. 5, when the solid particles 300 following the second flow trajectories 500 exit the dispersion nozzle 214 and enter the test chamber 216, a substantially parabolic erosion pattern 510 is created by the dispersion of the solid particles 300 in the test chamber 216. In some examples, the example parabolic erosion pattern 510 of FIG. 5 is at least partially flattened to increase uniformity of the pattern and reduce formation of, for example, substantially a non-uniform ring in the pattern corresponding to the walls of the dispersion nozzle 214. In some examples, the flattened parabolic shape is less pronounced along a major axis of erosion pattern (e.g., corresponding to the major axis of the diverging portion 410 of the dispersion nozzle 214). The erosion pattern 510 can have other shapes, sizes, etc. than the example of FIG. 5. Also, a velocity of the particle-injected air stream 402 can be controlled based on pressures in the dispersion chamber 204 and at the dispersion nozzle 214 where the particle-injected air stream 402 exits the dispersion chamber 204, as disclosed below. In some examples, a velocity of the solid particles 300 is adjusted to adjust uniformity of the erosion pattern 510.

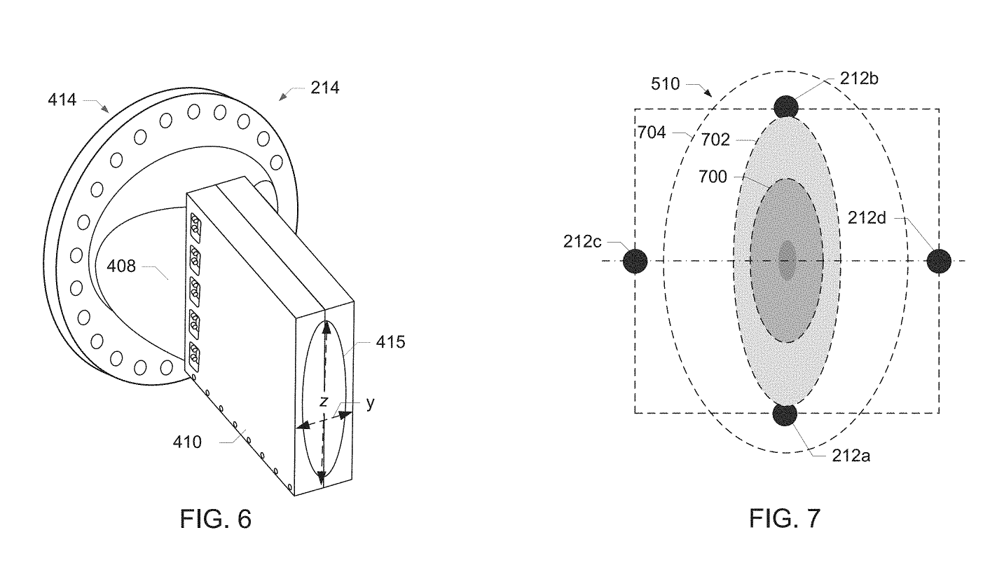

The creation of erosion pattern 510 (e.g., as shown in FIG. 7, below) by the dispersion of the solid particles 300 can be based on, for example, a concentration of the solid particles 300 emitted from one or more of the injectors 212a-212d. A flow rate of the solid particles 300 emitted by the nozzles 401 for dispersion into the air supply stream 312 can be selected (e.g., by a user via the processor 208) based on the type of erosion testing to be performed. For example, a solid particle flow rate of greater than 20 lbs/min can be selected for testing high durability materials and/or conducting failure tests. A solid particle flow rate of 5-15 lbs/min can be selected for testing materials of moderate durability. A solid particle flow rate of less than 1 lb/min can be used for testing low durability materials such as paint or windscreens. The solid particle flow rate can be selected based on other testing variables. For example, a slow particle flow rate may be selected for a test that includes monitoring erosion by isolating wear rates and/or failure modes of the test sample or portions thereof. A faster particle flow rate may be selected for testing a sample that had known wear durability and that is to undergo exposure for an extended period of time to increase efficiency of the test (e.g., reduce test time). Also, faster particle flow rates can reduce air flow duration, which decrease a demand on the air supply 310 of FIG. 3. Particle flow rates also affect a particle concentration of the erosive environment created in the test chamber 216. Variables such as particle mass per unit volume can be adjusted for tests that may be sensitive to particle concentrations. The flow rate of the air supply stream 312 can also be selectively adjusted based on the type of testing to be performed.

In some examples, one or more properties of the solid particles 300 affect the dispersion of the solid particles 300 and, thus, the creation of the erosion pattern 510. For example, a size, shape, and/or speed of the solid particles 300 can affect the ballistic behavior of the solid particles 300. As particle inertia increases, a probability that the solid particles 300 impact the test sample also increases (even if, for example, a trajectory of the solid particles 300 changes in the test chamber 216 due to the presence of the test sample 218). For example, larger sized solid particles 300 may travel along a more ballistic or straight flow path as compared to smaller sized solid particles 300, which may more closely follow the air flow path relative to the walls of the dispersion nozzle 214 and, thus, deflect over the test sample 218 after exiting the nozzle. Other characteristics of the solid particles 300, such as density, size, angularity, material, weight, etc. can also affect the dispersion of the solid particles with respect to the air supply stream 312, the particle flow rates, and/or the creation of the erosion pattern 510. For example, solid particles 300 having diameter between 100-250 μm, 200-600 μm, etc. can be used. In some examples, properties of particles such as an ability to flow relative to a threshold speed (which can affect an ability of the particles to effectively disperse into the air supply stream 312) affect the resulting dispersion pattern. Dispersion patterns can be adjusted based on selections and/or adjustments with respect to, for example, particle velocity, particle size, etc.

In the example of FIG. 5, the flow and/or dispersion of the solid particles 300 and, thus, the creation of the erosion pattern 510 can be controlled by one or more adjustments to the injectors 212a-212d. For example, respective dimensions (e.g., length, diameter, angle) of the injectors 212a-212d can affect the flow of the solid particles 300 into the dispersion chamber 204, such as with respect to velocity, concentration, pressure, etc., which can affect the mixing of the solid particles 300 with the air supply stream 312. Also a number the injectors 212a-212d that are selected to emit the solid particles 300 affects the dispersion of the solid particles 300 in the air supply stream 312 and the resulting erosion pattern 510.

In the example of FIG. 5, the value of the injection angle 407 affects the dispersion of the solid particles 300 in the particle-injected air stream 402 and, thus, the creation of the erosive pattern 510. For example, a larger injection angle 407 (e.g., 10-15 degrees) decreases a size of the resulting erosion pattern 510 as compared to smaller injection angle 407 (e.g., 5 degrees) based on, for example, the location of the intersection point 502, 506 of the solid particles 300 with respect to the converging and diverging portions 408, 410 of the dispersion nozzle 214. For example, a larger injection angle 407 can result in an erosion pattern having a more peaked (e.g., less flattened) parabolic shape and higher particle concentration a center of the test sample. In some examples, a larger injection angle 407 decreases a uniformity of a density of the solid particles 300 in the particle-injected air stream 402 as compared to a smaller injection angle 407 based on, for example, a position along the length of the dispersion chamber 204 at which the injectors 212a-212d are inserted into the dispersion chamber 204 to accommodate the selected injection angle 407.

In the example of FIG. 5, a velocity of the particle-injected air stream 402 can be adjusted or maintained based on pressures in the dispersion chamber 204 and at an exit 512 of the dispersion nozzle 214. In the example of FIG. 5, the test chamber 216 can include one or more static pressure taps or openings formed in the walls of the test chamber 216. A static pressure P_{static(exit)} can be measured at the exit 512 of the dispersion nozzle 214 based on the pressure in the tap(s) of the test chamber 216. Also, in the example of FIG. 5, the walls 406 of the dispersion chamber 204 include one or more static pressure taps formed therein. A total pressure Pₜₒₜₐₗ can be determined based on the static pressure tap(s) in the dispersion chamber 204. The velocity of the particle-injected air stream 402 can be controlled by maintaining or adjusting P_{static(exit)}/Pₜₒₜₐₗ to reproduce environments to which the test sample 218 would be exposed to the particle-injected air stream 402. The measurements of the velocity using the static pressure measurements at the dispersion chamber 204 and the test chamber 216 provide for control of the particle-injected air stream despite any wear at the dispersion nozzle 214 and substantially eliminate a need for velocity measurements of the solid particles 300 at the test chamber 216 (and, thus, a need for velocity measuring instruments to be disposed in the test chamber 216).

In some examples, the dispersion of the solid particles 300 into the air supply stream 312 can be controlled by adjusting a pressure in the injectors 212a-212d relative to Pₜₒₜₐₗ via the pressure control system 206 of FIGS. 2 and 3. In some examples, factors such as ambient pressure, air temperature, temperature in the dispersion chamber 204, etc. can affect the equalization of the velocity of the solid particles 300 with the velocity of the air supply stream 312 and/or the velocity of the particle-injected air stream 402 that exits the dispersion nozzle 214.

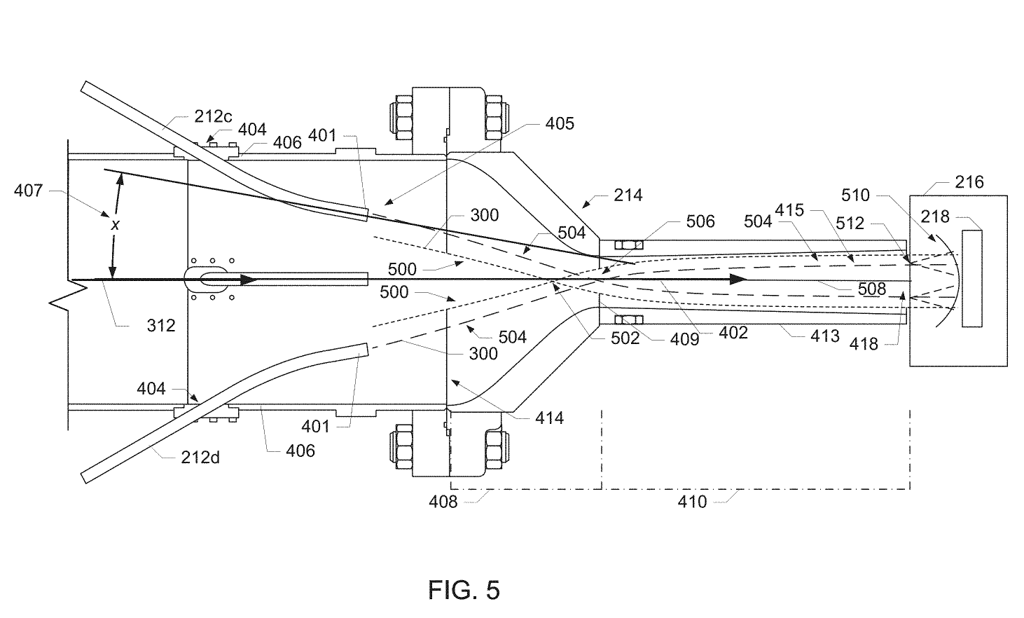

FIG. 6 is a schematic illustration of the example dispersion nozzle 214 of FIGS. 4 and 5 and, in particular, shows the elliptical shape of a portion of the example dispersion nozzle 214. As shown in FIG. 6, the entrance 414 of the dispersion nozzle 214 has a substantially circular shape. As disclosed above, a cross-sectional shape of the dispersion nozzle 214 changes from a substantially circular shape to the substantially elliptical shaped throat 409 via the converging portion 408, which along with the diverging portion 410, provides for substantially uniform dispersion of the solid particles 300 with the air supply stream 312. Also, the contour 415 of the diverging portion 410 of the dispersion nozzle 214 (where an example cross-sectional view of the contour 415 shown in FIGS. 4 and 5) affects the trajectories (e.g., the example trajectories 500, 504 of FIG. 5) of the solid particle and, thus, the dispersion of the solid particles 300 with the air supply stream 312. As disclosed above, the contour of the diverging portion 410 can have a substantially non-linear shape. For example, variables such as particle momentum, velocity, and/or particle flow trajectory cross-sections can be adjusted to enable the solid particles to follow the path of air flow.

The converging portion 408 and the substantially elliptical cross-sectional shape of the diverging portion 410 of the example dispersion nozzle 214 facilitates acceleration of the solid particles 300 and/or the particle-injected air stream 402 to, for example, equalize speeds of the solid particles 300 and the air. As illustrated in FIG. 6, the elliptical portion of the dispersion nozzle 214 has a minor axis y and a major axis z. In operation, the major axis z can be oriented vertically relative to the test sample 218 to effect a desired erosion pattern based on, for example, geometry of the test sample and/or an orientation of the test sample within the test chamber 216. As noted above, the diverging portion 410 can have a different cross-section, such as a circular cross-section based on, for example, a desired erosion pattern (e.g., a size of the erosion pattern) relative to a size and/or geometry of the test sample 218. In some examples, a uniformity of the pattern is affected by the cross-section of the diverging portion 410 of the dispersion nozzle as a result of the effect of the cross-section on the particle flow trajectories and dispersion (e.g., an elliptical cross-section may provide increased uniformity of the erosion pattern 510 as compared to a circular cross-section).

When the dispersion nozzle 214 of FIG. 6 is coupled to the test chamber 216 and serves as an inlet for the particle-injected air stream 402 into the test chamber 216, the minor axis y reduces a cross-sectional area of an inlet as compared to a circular shaped inlet. The reduction in the cross-sectional area allows the dispersion and a flow rate of the solid particles 300 to be more accurately controlled with respect to a uniform dispersion of the erosion pattern relative to, for example, a geometry and/or orientation of the test sample 218 as compared to a circular inlet for creation of different erosion patterns. For example, as disclosed above, the elliptical cross-sectional shape of the diverging portion 410 allows for the creation of the erosion pattern 510 of FIG. 5 having a substantially parabolic shape (e.g., along the major and minor axes). Thus, the geometry of the dispersion nozzle 214 helps to define flow field patterns across the test sample 218. Further, the erosion pattern can be defined based on other factors such as particle speed, particle shape, particle size, air flow, test sample geometry, etc.

The respective sizes of the minor axis y and the major axis z of the diverging portion 410 of the dispersion nozzle 214 can be selected to adjust a shape of the elliptical cross-section and/or be selected based on, for example, one or more test samples 218 (e.g., wings, rotor blades) that are to be tested in the test chamber 216. For example, the major axis z can be larger than a thickness of the test sample 218 to allow the particle-injected air stream 402 to flow above and below the test sample 218 and expose a height of the test sample 218 to the erosion pattern (e.g., the erosion pattern 510 of FIG. 5). In some examples, the major axis z has a length of 19 inches. A size of the minor axis y can be selected to expose, for example, a central portion of a span of the test sample 218 to the erosion pattern.

FIG. 7 illustrates the example erosion pattern 510 to which the sample 218 can be exposed from the ejection of the particle-injected air stream 402 from the example dispersion nozzle 214 of FIGS. 4-6. As illustrated in FIG. 7, the example erosion pattern 510 can be substantially parabolic. In some examples, the erosion pattern 510 has a substantially flattened parabolic shape. In some examples, the shape of the erosion pattern and/or portions of the erosion pattern are determined based on a size of the test sample 218 and/or an area of interest of the test sample 218 to be exposed to the erosive air stream. Also, different degrees of erosion can be simulated based on dispersion trajectories of the solid particles 300 after emission from the dispersion nozzle 214 of FIGS. 4-6. FIG. 7 includes representations of the injectors 212a-212d to illustrate the effect of the dispersion nozzle 214 in creating the substantially parabolic shaped erosion pattern 510 (e.g., via the converging and diverging portions 408,410 of the dispersion nozzle 214 of FIGS. 4 and 5) as compared to the positions of the injectors 212a-212d.

For example, a first portion 700 of the erosion pattern 510 can replicate 90%-100% erosion (i.e., 10% uniformity of erosion rate) of a portion of the test sample 218 exposed to the first portion 700 (e.g., more concentrated exposure to the solid particles 300). The first portion 700 can represent a uniformity region with respect to the solid particles 300 and the air flow generated based on, for example, a size of the test sample and adjustment flow characteristics of the solid particles 300 and/or the air. A second portion 702 of the erosion pattern 510 can replicate 50% erosion of a portion of the test sample 218 exposed to the second portion 702 and a third portion 704 of the erosion pattern 510 can replicate 10% erosion of a portion of test sample 218 exposed to the third portion 704 (e.g., less concentrated exposure to the solid particles 300). Thus, the trajectories of the solid particles 300 as a result of, for example, the elliptical shape of diverging portion 410 of the dispersion nozzle 214 provides for a range of erosive effects to be produced. An erosion decay pattern can be used to evaluate erosion of the test sample 218 over a range of wear rates. In some examples, sizes of the minor axis y and/or the major axis z are selected to produce different erosion patterns and/or to expose, for example, a larger portion of the test sample 218 to the more concentrated particle dispersion represented by the first portion 700 of the example erosion pattern 510. In addition to a shape of the dispersion nozzle 214, the erosion pattern 510 can be adjusted based on, for example, a size of the test sample 218 and/or a position of the test sample 218 in the test chamber 216 relative to the dispersion nozzle 214.

Thus, the example dispersion chamber 204 and the example dispersion nozzle 214 provides a source mixture of solid particles 300 and air that that creates a substantially realistic aerodynamic flow field. The dispersion chamber 204 and the dispersion nozzle 214 promote uniformity with respect to dispersion of the solid particles 300 with the air supply stream 312 as well as velocities of the solid particles 300 relative to the velocity of the air. Selective adjustments with respect to, for example, an angle at which the solid particles 300 are emitted from the injector(s) 212a-212d and/or pressures in the in the injector(s) 212a-212d and/or the dispersion chamber 204 can be made to control the flow rate and speed of the solid particles and define the erosion pattern 510. The dispersion nozzle 214 provides for controlled dispersion and speed of the solid particles 300 that results in an accurate simulation of an erosive flow field for a duration of the test.

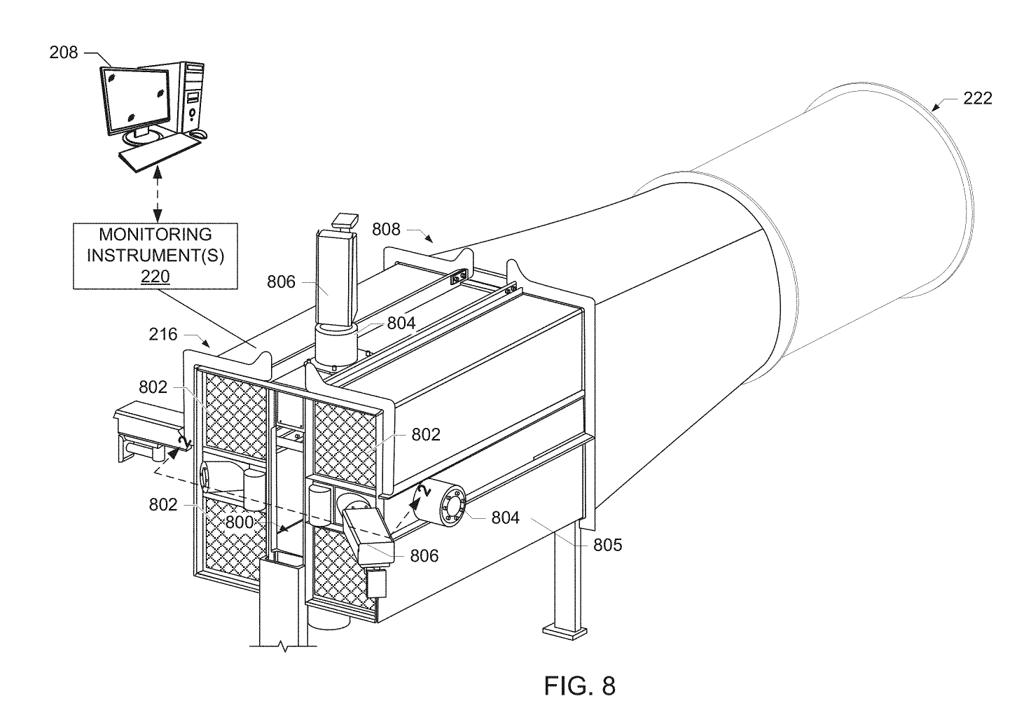

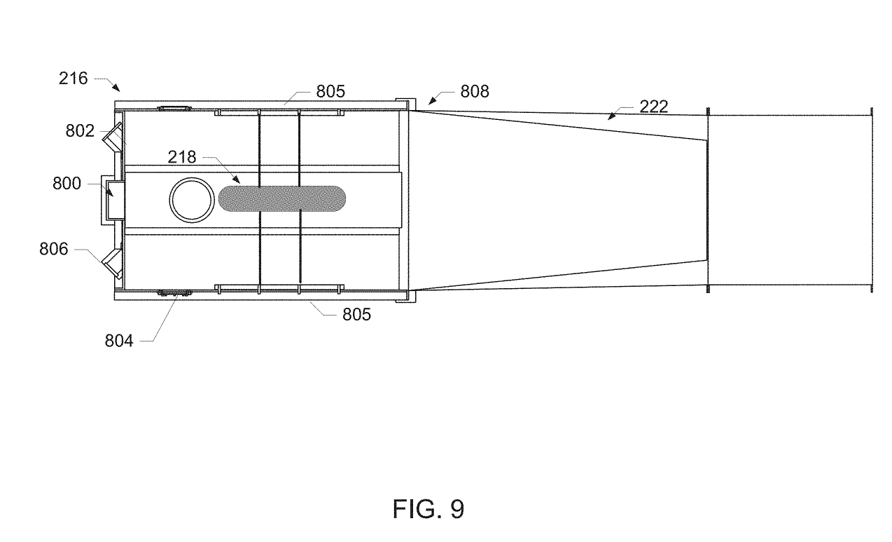

FIG. 8 is perspective view of the example test chamber 216 and the example duct 222 of FIG. 2. FIG. 9 is a cross-sectional view of the example test chamber 216 and the duct 222 including the test sample 218 disposed in the test chamber 216. For illustrative purposes, only a portion of the duct 222 is shown in FIGS. 8 and 9.

As illustrated in FIGS. 8 and 9, the example test chamber 216 includes an inlet 800 to which the diverging portion 410 of the dispersion nozzle 214 of FIGS. 4-5 is coupled for the introduction of the particle-injected air stream 402 into the test chamber 216. In the example of FIGS. 8 and 9, an expansion ratio of the outlet of the dispersion nozzle 214 to the test chamber 216 is substantially large over a length of the test chamber 216 extending beyond the test sample 218 disposed in the test chamber 216 such that the test chamber 216 acts as a diffuser to substantially remove back pressure. As will be disclosed below, orientation (e.g., a pitch angle) of the test sample 218 relative to the dispersion nozzle 214 can be adjusted. In some examples, the orientation of the test sample to the nozzle increases flow blockage. The example system 200 of FIGS. 2-6, 8, and 9 can accommodate different combinations of air and particles speeds and volume, test sample size, and/or obstructions in the flow path due to the orientation of the test sample 218.

The example test chamber 216 of FIGS. 8 and 9 includes one or more vents 802. During testing, ambient air from, for example, the environment in which the test chamber 216 is located (e.g., air other than the particle-injected air stream 402 entering via the dispersion nozzle 214) is drawn into the test chamber 216 via the vent(s) 802. Without the introduction of ambient air into the test chamber 216, the inlet 800 (e.g., to which the dispersion nozzle 214 is coupled) would create a suction that could prevent the particle-injected air stream 402 from flowing around the test sample 218 and, thus, would not realistically simulate flight conditions. The vent(s) 802 facilitate of the particle-injected air stream 402 in the test chamber 216 to substantially simulate free jet expansion conditions at in the environment being replicated (e.g., the environment 100 of FIG. 1) and substantially prevents recirculation of the particle-injected air stream 402 in the test chamber 216. The introduction of ambient air into the test chamber 216 also creates an atmosphere in the test chamber that more realistically simulates, for example, the environment 100 of FIG. 1. The example test chamber 216 can include additional or fewer vents 802 than illustrated in FIG. 8.

The example test chamber 216 includes one or more windows 804 coupled to the walls 805 of the test chamber 216 to provide for viewing of the test sample 218 disposed in the test chamber 216. In some examples, the window(s) 804 are located proximate to the vents 802 such that the ambient air entering the vents 802 prevents the solid particles 300 from collecting in the windows 804 and obscuring the window(s) 804. In some examples, the window(s) 804 can be adjusted (e.g., slid) for viewing different portions of the test sample 218. The window(s) 804 can include, for example, sapphire coated glass to withstand exposure to the particle-injected air stream 402. In some examples, mount standoffs for the window(s) 804 include perforations, which draw in ambient air to substantially prevent the solid particles from interacting with the glass. The example test chamber 216 can include additional and/or fewer windows 804 than shown in FIG. 8.

As disclosed above with respect to FIG. 2, the example test chamber 216 includes one or more monitoring instruments 220 to collect data during testing. For example, the test chamber 216 includes one or more cameras 806. The camera(s) 806 can be coupled to the respective viewing windows 804. The camera(s) 806 can be moveable (e.g., slidable, rotatable, etc.) relative to the test sample 218 disposed in the test chamber 216 via, for example, one or more support platforms to which the camera(s) 806 and/or the window(s) 804 are coupled. A position of the camera(s) 806 can be selected based on, for example, a position of the test sample 218 in the test chamber 216, one or more portions of the test sample 218 (e.g., top, side) that are to be captured via the camera(s) 806, lighting, etc. The positon of the camera(s) 806 can be adjusted based on instructions received via the processor 208. In other examples, the positons of the camera(s) 806 can be manually adjusted by a user. The camera(s) 806 can collect one or more images or videos of the test sample 218 before, during, and/or after testing, record the duration of exposure of the test sample 218 to the solid particles 300, etc. In some examples, the monitoring instruments 220 include lasers that emit a laser beam through the window(s) 804 to collect particle image velocimetry (PIV) data with respect to a velocity of the particle-injected air stream 402.

The example test chamber 216 can include other data collection and/or monitoring instruments 220. For example, the test chamber 216 can include sensors to measure test parameters such as air temperature, pressure, humidity, sample strain, wear detection, etc. In some examples, the test chamber 216 includes sensors to measure light emission and/or temperature changes from interactions of the solid particles 300 with the test sample 218.

The data collected by the camera(s) 806 and/or the other monitoring instruments 220 is transmitted to (e.g., wirelessly) and stored by the processor 208, In some examples, data such as images and/or videos collected by the camera(s) 806 can be viewed in substantially real-time (e.g., via a display associated with the processor 208). For example, a substantially live video feed can be viewed by a user with respect to particle interactions with a surface of the test sample 218. In other examples, the data collected by the monitoring instruments 220 is viewed and/or analyzed at a later time.

The data collected by the camera(s) 806 and/or the other monitoring instruments 220 can be analyzed by the processor 208 to, for example, generate time-lapse videos and analyze the resulting videos in view of test parameters such as flow air, air speed, a volume and/or type of the solid particles 300, and/or particle exposure time. The data can also be analyzed with respect to the size, geometry, orientation, etc. of the test sample 218 in the test chamber 216. The data collected by the monitoring instruments 220 (e.g., the camera(s) 806) can be analyzed with respect to damage to the test sample 218 after testing, surface roughness, mass change, material thickness changes, etc.

In some examples, the example system 200 of FIGS. 2-8 can be used to evaluate repairs to the test sample 218, material(s) of the test sample 218, and/or design of the test sample 218. In some examples, the test sample 218 is exposed to the particle-injected air stream 402 to pre-condition the surface(s) of the test sample 218 before other tests, such as rain erosion tests or ice accretion tests.

As illustrated in FIGS. 8 and 9, the test chamber 216 includes an outlet 808. After the particle-injected air stream 402 flows past the test sample 218 in the test chamber 216, the particle-injected air stream 402 exits the test chamber 216 via the outlet 808. The outlet 808 is coupled to the duct 222. In the example test chamber 216 of FIGS. 8 and 9, the outlet 808 has a converging shape that transitions from a substantially square cross-sectional shape proximate to the test chamber 216 to a substantially circular cross-sectional shape proximate to the duct 222. The converging shape of the outlet 808 facilitates continued flow of the particle-injected air stream 402 away from the test chamber 216 toward the duct 222. The outlet 808 helps to reduce back pressure to enable the particle-injected air stream 402 to flow around the test sample 218.

The example duct 222 of FIGS. 8 and 9 couples the test chamber 216 and the particle collection chamber 224 of FIG. 2. As illustrated in FIG. 8, a diameter of the duct 222 decreases over the length of the duct 222. The decreasing diameter of the duct 222 increases the velocity of the solid particles 300 of the particle-injected air stream 402 flowing through the duct 222. The increased velocity of the solid particles 300 in the duct 222 facilitates the collection the solid particles 300 by the particle collection chamber 224. Thus, the particle collection chamber 224 provides for an open-loop test, such that the solid particles 300 are not re-circulated. In other examples, the solid particles 300 can be screened (e.g., using imaging and with respect to parameters such as particle shape) before being dispersed into the air supply stream 312 (e.g., in the particle hopper 210) and/or after being collected by the particle collection chamber 224 to determine if any of the solid particles 300 (e.g., the solid particles that did not impact the test sample 218) can be re-introduced into the particle hopper 210. Such re-introduction of unaffected particles can increase test efficiency and reduce costs. The duct 222 also provides for filtration and ventilation to reduce back pressure that could otherwise affect the testing occurring in the test chamber 216. As shown in FIG. 2, in some examples, at least a portion of the duct 222 is bent and/or angled to couple with the particle collection chamber 224. The collection of the solid particles in the particle collection chamber 224 protects users of the example system 200 from health hazards associated with particles such as fine silica. The collection of the solid particles in the particle collection chamber 224 also provides for compliance with air quality standards (e.g., as set by the Environmental Protection Agency) with respect to the environment in which the example system 200 is located.

FIG. 10 is a partial view of the interior of the test chamber 216 including the test sample 218 disposed therein. As illustrated in FIG. 10, the test sample 218 can be an airfoil. The test sample 218 can have other shapes, such as cylindrical, flat, etc. The example test chamber 216 includes a rack 1000 to support the test sample 218. The example rack 1000 includes one or more shafts or rods 1002 that extend through apertures 1004 formed in the test sample 218. The apertures 1004 can be formed in the test sample 218 at different positions than shown in FIG. 10 to allow the test sample 218 to be positioned in the test chamber 216 in different orientations.

The example rack 1000 is slidable relative to the walls 805 of the test chamber 216 to adjust a distance between the test sample 218 and the inlet 800 of the test chamber 216. For example, a distance between the inlet 800 and test sample 218 can be adjusted between a range of 0 inches to 28.5 inches. In some examples, the rods 1002 of the rack 1000 can be rotated to adjust an angle of the test sample 218 in the test chamber 216 to substantially replicate an interaction of the test sample 218 with the environment. For example, an angle of the test sample 218 can be adjusted +/−12 degrees relative to the minor axis of dispersion nozzle 214. The position of the rack 1000 can be manually adjusted by a user or by adjusted by robotic controller (e.g., via the processor 208). The position, angle, or more generally, the orientation of the test sample 218 relative to the inlet 800 can be adjusted to simulate different angles of exposure of the test sample 218 to the particle-injected air stream 402. In some examples, the orientation of the test sample 218 can be adjusted before and/or during testing (e.g., via a robotic controller). In some examples, the test sample 218 is adjusted during testing to substantially replicate aerodynamic body movements of the test sample 218 during flight conditions, such as pitching of rotor blades to cause changes in lift or direction, to modify rotor azimuth position, etc.

FIG. 10 illustrates an example flow of the particle-injected air stream 402 around the test sample 218 as represented by arrows 1006. As illustrated in FIG. 10, the particle-injected air stream 402 enters the test chamber 216 via dispersion nozzle 214 coupled to the inlet 800 of the test chamber 216 and flows around (e.g. over, under) the test sample 218. In some examples, larger solid particles 300 travel in a ballistic manner such that the particles 300 travel in a substantially straight line toward the test sample 218 and smaller solid particles 300 flow with the air over or under the test sample 218. One or more properties such as particle size, particle concentration, particle speed, etc. can affect an interaction of the solid particles 300 with the test sample 218, including a collection efficiency, or an extent to which the solid particles 300 impinge or impact the test sample 218 as compared to flowing around the test sample 218 due to the presence of the test sample 218 in the test chamber 216. Thus, the dispersion nozzle 214 provides for substantially uninterrupted flow around the test sample 218.

As illustrated in FIG. 10, the test sample 218 is orientated such that the airfoil spans along the minor axis of the dispersion nozzle 214 and a chord height of the test sample 218 is along the major axis of the dispersion nozzle 214. As a result of such positioning of the test sample 218, a leading edge 1008 and at least a portion of an upper surface 1010 and/or a lower surface 1012 proximate to the leading edge 1008 of the test sample 218 where erosion wear typically occurs are substantially exposed to the particle-injected air stream 402. In other examples, an angle of the test sample 218 can be adjusted such that the lower surface 1012 of the test sample 218 has increased exposure to the particle-injected air stream 402 as compared to the upper surface 1010. In other examples, the test sample 218 is positioned such that a span of the test sample 218 is along the major axis of the dispersion nozzle 214. Such a position may be used for smaller sized samples or to substantially expose the span of the test sample 218 to the particle-injected air stream 402. In some examples, a position of the test sample 218 is based on, for example, a velocity of the particle-injected air stream 402.

Thus, the example test chamber 216 enables the particle-injected air stream 402 to flow relative to the test sample 218 to substantially simulate environmental conditions to which the test sample 218 would be exposed during flight. In some examples, the solid particles 300 separate from the air of the particle-injected air stream 402 upon impact with the test sample 218 and then re-entrain with the air after impact. As disclosed above with respect to FIG. 2, After the particle-injected air stream 402 flows past the sample 218, the particle-injected air stream 402 enter the duct 222 and flows into the particle collection chamber 224, where the solid particles 300 are collected and stored in the particle collection chamber 224.

While an example manner of implementing the example system 200 is illustrated in FIGS. 2-6 and 8-10, one or more of the elements, processes and/or devices illustrated in FIGS. 2-6 and 8-10 may be combined, divided, re-arranged, omitted, eliminated and/or implemented in any other way. Further, the example pressure control system 206, the example processor 208, the example monitoring instruments 220, the example cameras 806, and/or, more generally, the example system 200 of FIGS. 2-6 and 8-10 may be implemented by hardware, software, firmware and/or any combination of hardware, software and/or firmware. Thus, for example, any of the example pressure control system 206, the example processor 208, the example monitoring instruments 220, the example cameras 806, and/or, more generally, the example system 200 of FIGS. 2-6 and 8-10 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example pressure control system 206, the example processor 208, the example monitoring instruments 220, the example cameras 806, and/or, more generally, the example system 200 of FIGS. 2-6 and 8-10 is/are hereby expressly defined to include a tangible computer readable storage device or storage disk such as a memory, a digital versatile disk (DVD), a compact disk (CD), a Blu-ray disk, etc. storing the software and/or firmware. Further still, the example system of FIGS. 2-6 and 8-10 may include one or more elements, processes and/or devices in addition to, or instead of, those illustrated in FIGS. 2-6 and 8-10, and/or may include more than one of any or all of the illustrated elements, processes and devices.

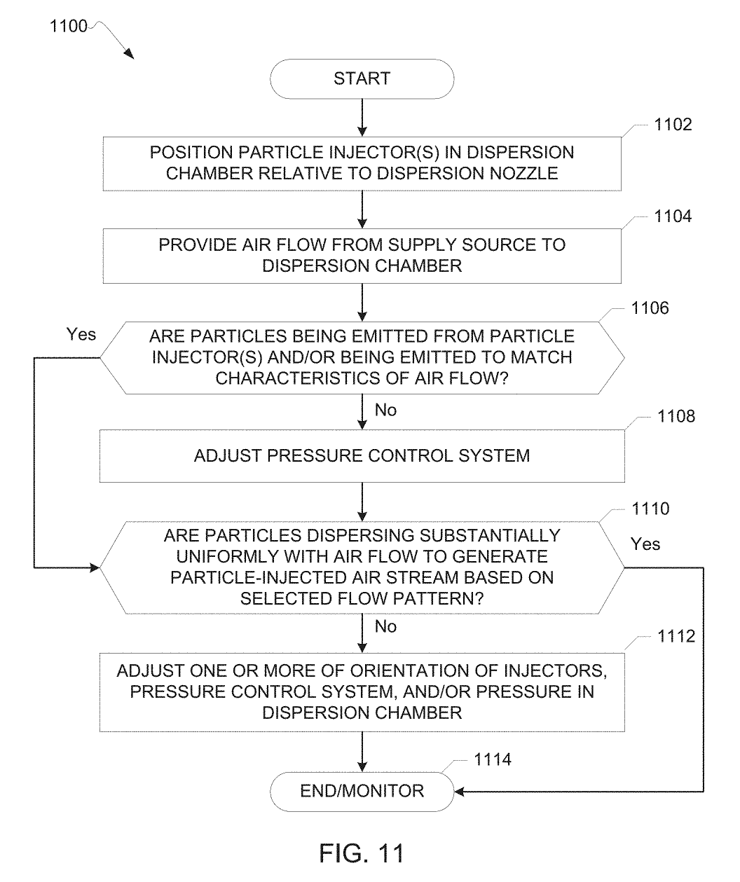

FIG. 11 illustrates a flowchart representative of an example method 1100 that can be implemented to generate a particle-injected air stream (e.g., the particle-injected air stream 402 of FIGS. 4 and 5). The example method 1100 can be implemented by, for example, the example pressure control system 206 and the example dispersion chamber 204 of the example system 200 of FIG. 2. The example method 1100 can be implemented by the example processor 208 of FIG. 8 based on, for example, one or more user inputs received by the processor 208.

The example method 1100 begins with positioning one or more particle injectors (e.g., the injectors 212a-212d of FIGS. 2-5) in a dispersion chamber (e.g., the dispersion chamber 204 of FIGS. 2, 4-5) relative to a dispersion nozzle (e.g., the dispersion nozzle 214 of FIGS. 2, 4-5) (block 1102). For example, a length of the particle injector(s) disposed in the dispersion chamber and/or an angle at which the particle injector(s) are disposed (e.g., the injection angle 407) in the dispersion chamber can be selectively adjusted.

The example method 1100 includes providing an air flow from a supply source to the dispersion chamber (block 1104). For example, supply air (e.g., the air supply stream 312 of FIG. 3) can be delivered to the dispersion chamber from an air supply (e.g., the air supply 310 of FIG. 3) via an air feed coupled to the dispersion chamber (e.g., the air feed 202 of FIG. 2). The delivery of the air flow can be controlled by one or more user inputs received via a processor (e.g., the processor 208 of FIG. 2).

The example method 1100 includes a determination of whether solid particles such as sand (e.g., the solid particles 300 of FIG. 3) are being emitted from the particle injector(s) and/or whether the solid particles are being emitted to substantially match one or more characteristics of the air flow (e.g., a velocity of the air supply stream 312) (block 1106). For example, if properties of the solid particles such as particle speed and/or flow rate do not substantially match the air flow, the example method include adjusting a pressure control system (e.g., the pressure control system 206 of FIGS. 2 and 3) to adjust the one or more properties of the solid particles when the solid particles exit the injector(s) (block 1108). Also, if the solid particles are not being emitted from the particle injector(s), the example method 1100 includes adjusting the pressure control system for regulating the emission of the solid particles (block 1108). For example, adjusting the pressure control system can include adjusting a pressure of a supply tank (e.g., the supply tank 305 of FIG. 3) that supplies pressure to a particle hopper that stores the solid particles (e.g., the particle hopper 210 of FIGS. 2 and 3). In other example, adjusting the pressure control system includes adjusting a pressure of the particle hopper (e.g., such that the pressure Pₕₒₚₚₑᵣ of particle hopper 210 is greater than the respective pressure(s) at the ejector supply lines 318a-318d of FIG. 3). The adjustment of the pressure control system can be performed by a processor (e.g., the processor 208).

If the solid particles are being emitted from the particle injector(s) or if the pressure control system has been adjusted such that the particles are being emitted from the particle injector(s), the example method 1100 includes a determination of whether the solid particles are dispersing substantially uniformly with the air flow from the supply source to generate the particle-injected air stream based on a selected flow pattern (block 1110). The determination of whether the particles are dispersing substantially uniformly with the air flow relative to a selected flow pattern can be based on, for example, an evaluation of a pressure in the dispersion chamber relative to a pressure at the particle injectors, a quantity of the particles being emitted by the particles injectors relative to a volume of the air flow, a velocity of the air flow relative to a velocity of the solid particles, an angle at which the particle injectors are positioned in the dispersion chamber, etc. The analysis of the dispersion of the particles can be performed by a processor (e.g., the processor 208 of FIG. 2). In some examples, the analysis of the dispersion can be verified based on a desired erosion pattern relative to a calibration test sample. In other examples, the example test chamber 216 includes an in-situ monitoring system to monitor erosion conditions at the test sample 218 such as wear, displacement, strain, etc. The erosion condition measurement(s) from the test sample 218 can be used to verify dispersion uniformity, patterns, and/or conditions in the test chamber and/or to determine if adjustments are need to the particle-injected air flow to achieve desired test conditions.

If the solid particles are not dispersing substantially uniformly with the air flow, the example method 1100 includes adjusting one or more of an orientation of the particle injector(s), the pressure control system, and/or a pressure in the dispersion chamber (block 1112). The adjustments can be performed by a processor (e.g., the processor 208 of FIG. 2). For example, the angle at which the particle injector(s) emit the solid particles into the dispersion chamber can be adjusted to adjust the dispersion trajectories of the solid particles as the particles mix with the air flow. As another example, the pressure at the particle injectors can be adjusted (e.g., via the pressure control system 206) relative to the pressure in the dispersion chamber. For example, the pressure at the particle injectors and/or the pressure in the dispersion chamber can be adjusted such that the pressure at the particle injector(s) is greater than the pressure at the dispersion chamber to allow the solid particles to gradually flow into the dispersion chamber. The gradual flow of the particles into the dispersion chamber facilitates substantially uniformly mixing of the particles with the air flow to create the particle-injected air stream.

If a determination is made that the particles are dispersing substantially uniformly with the air flow, the example method 1100 ends with monitoring the delivery of the particles and/or the air supply flow to generate the particle-injected air stream (block 1114).

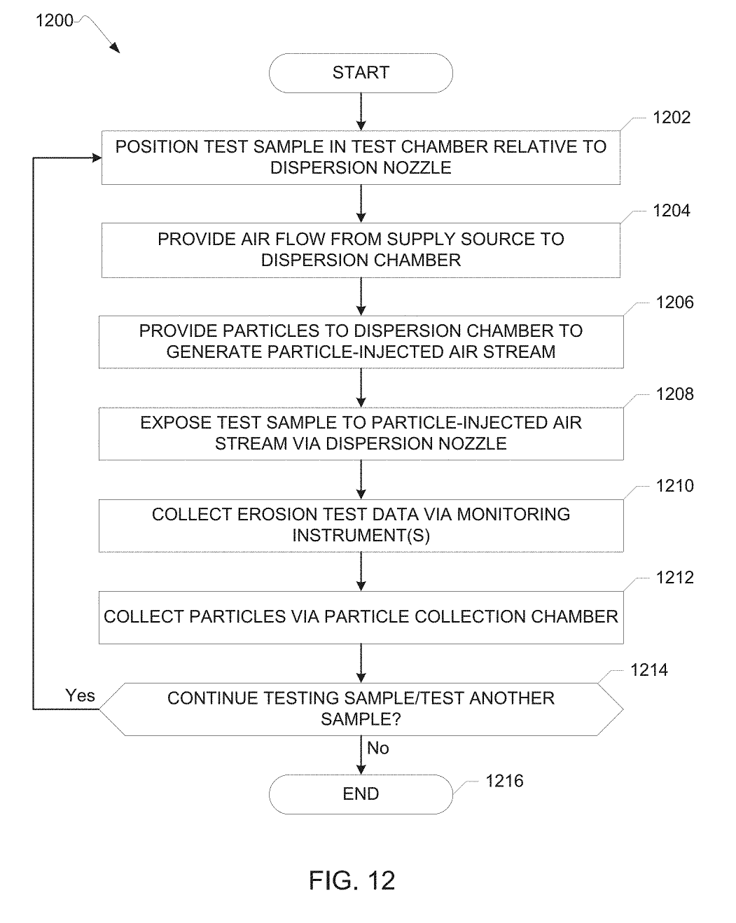

FIG. 12 illustrates a flowchart representative of an example method 1200 that can be implemented to perform an erosion test on a test sample (e.g., the test sample 218 of FIG. 2). The test sample can include, for example, a wing or a rotor blade of an aircraft (e.g., the example vehicle 102 of FIG. 1) or a portion thereof. The example method 1100 can be implemented by the example system 200 of FIGS. 2-6, 8-10. The example method 1100 can be implemented by the example processor 208 of FIG. 8 based on, for example, one or more user inputs received by the processor 208.

The example method 1200 begins with positioning a test sample in a test chamber (e.g., the test chamber 216 of FIG. 2) relative to a dispersion nozzle (e.g., the dispersion nozzle 214 of FIG. 2) (block 1202). The test sample can be disposed in the test chamber via a rack that supports the test chamber (e.g., the rack 1000 of FIG. 10). Positioning the test sample in the test chamber can include, for example, adjusting an angle of the test sample and/or an orientation of the test sample 218 (e.g., horizontal, vertical) relative to the dispersion nozzle via the rack (e.g., by rotating the rods 1002 of the rack 1000). Positioning the test sample can also include adjusting a distance of the test sample relative to the dispersion nozzle by, for example, sliding the rack along walls (e.g., the walls 805 of FIG. 8) of the test chamber. In some examples, the positioning of the test sample is controlled via a processor (e.g., the processor 208 of FIG. 2).

The example method 1200 includes providing an air flow from a supply source to the dispersion chamber (block 1204). For example, supply air (e.g., the air supply stream 312 of FIG. 3) can be delivered to the dispersion chamber (e.g., the dispersion chamber 204) from an air supply (e.g., the air supply 310 of FIG. 3) via an air feed coupled to the dispersion chamber (e.g., the air feed 202 of FIG. 2). The delivery of the air flow can be controlled by one or more user inputs received via a processor (e.g., the processor 208).

The example method 1200 includes providing solid particles (e.g., the solid particles 300 of FIG. 3) to the dispersion chamber to generate a particle-injected air stream (e.g., the particle-injected air stream 402 of FIG. 4) (block 1206). In the example method of FIG. 12, the solid particles are provided to the dispersion chamber via particle injectors (e.g., the injectors 212a-212d) to generate the particle-injected air stream as substantially disclosed above with respect to the example method 1100 of FIG. 11. For example, a position of the particle injectors and/or pressures at the particle injectors and/or the dispersion chamber can be adjusted to enable the solid particles to substantially uniformly disperse with the supply air to generate the particle-injected air stream. The delivery of the solid particles can be controlled by one or more user inputs received via a processor (e.g., the processor 208).

The example method 1200 includes exposing the test sample to the particle injected air stream (block 1208) via the dispersion nozzle. For example, the delivery of the supply air and the solid particles can be activated and/or maintained (e.g., via the processor 208) such that the particle-injected air stream is generated and flows into the test chamber via the dispersion nozzle for a predetermined duration of time. In the example method 1220, the test sample is exposed to the particle-injected air stream substantially continuously over the duration of the test.

The example method 1200 includes collecting erosion test data via one or more monitoring instruments (block 1210). The monitoring instruments (e.g., the monitoring instruments 220) can include, for example, one or more camera(s) (e.g., the cameras 806 of FIG. 8). For example, the camera(s) can collect images and/or record video of the test sample before, during, and/or after exposure of the test sample to the particle-injected air stream. In some examples, the positon of the cameras can be adjusted relative to the position of the test sample (e.g., by via instructions received via a processor or manually by a user). The data collected by the camera and/or other monitoring instruments (e.g., sensors) can be transmitted to a processor (e.g., the processor 208 of FIG. 2) for storage and analysis of the erosive effect of the particle-injected air stream on the test sample.

The example method 1200 includes collecting the solid particles via a particle collection chamber (block 1212). In the example method 1200, after the particle-injected air stream flows through the test chamber, the particle-injected air stream flows to the particle collection chamber (e.g., the particle collection chamber 224 of FIG. 2), where solid particles are collected and/or stored. In some examples, the particles are not re-circulated. In other examples, the particles are screened to separate out particles that were unaffected by the testing for possible re-use for other erosion tests.

The example method 1200 includes a determination of whether testing of the sample is to continue or whether another sample is to be tested (block 1214). For example, another erosion test can be performed to test a different material and/or design than the material and/or design of the test sample previously tested. In some examples, the same sample is re-tested to further expose the test sample to the erosive flow field created by the particle-injected air stream. If a decision is made to conduct further testing, the example method 1200 returns to positioning the test sample to be tested in the test chamber (block 1202). If no further testing is to be conducted, the example method 1200 ends (block 1216).

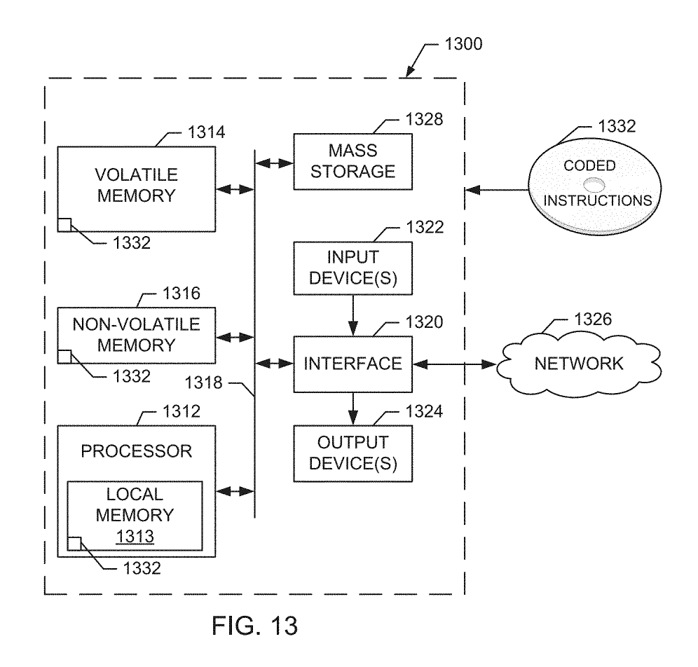

The flowcharts of FIGS. 11 and 12 are representative of example methods that may be used to implement the system of FIGS. 2-6 and 8-10. In these examples, the methods may be implemented using machine-readable instructions that comprise a program of execution by a processor such as the processor 1312 shown in the example processor platform 1300, discussed below in connection with FIG. 13. The program may be embodied in software stored on a tangible computer readable storage medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 11 and 12, many other methods of implementing the example systems 200 of FIGS. 2-6 and 8-10 may alternatively be used. For example, the order of execution of the blocks may be changed, and/or some of the blocks described may be changed, eliminated, or combined.

As mentioned above, the example processes of FIGS. 11 and 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 11 and 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 13 is a block diagram of an example processor platform 1300 capable of executing the methods of FIGS. 11 and 12 and the example system 200 of FIGS. 2-6 and 8-10. The processor platform 1300 can be, for example, a server, a personal computer, a mobile device (e.g., a cell phone, a smart phone, a tablet such as an iPad™), a personal digital assistant (PDA), an Internet appliance, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

Coded instructions 1332 to implement the methods of FIGS. 11 and 12 may be stored in the mass storage device 1328, in the volatile memory 1314, in the non-volatile memory 1316, and/or on a removable tangible computer readable storage medium such as a CD or DVD.

From the foregoing, it will be appreciated that the above disclosed methods, apparatus and articles of manufacture provide for controlled dispersion of solid particles in source air to generate a particle-injected air stream that can be used to replicate an aerodynamic flow field to which a test sample is exposed. Variables such as air speed, particle quantities, particle speed, particle size, particle shape, particle uniformity, a size of an erosion pattern, a shape or form of the erosion pattern, etc. can be controlled and/or adjusted to generate different erosion environments via the substantially uniform dispersion of the particles in the air stream. During testing, the particle-injected air stream flows around a test sample in a substantially continuous manner to accurately simulate flow fields to which the test sample may be exposed in operation. Disclosed examples provide for flow of the particle-injected air stream without back pressure and based on, for example, an orientation and/or geometry of the test sample to control an interaction of the test sample with the erosive environment. Disclosed examples provide for accurate and consistent erosion testing results via a robust, durable system that simulates full scale erosive aerodynamic flow environments.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a particle dispersion chamber, the particle dispersion chamber having a first end and a second end opposite the first end;
an air supply feed coupled to the first end to provide air flow to the particle dispersion chamber;
a first nozzle adjacent the second end; and
an injector extending into the particle dispersion chamber, the injector to inject particles into the air flow to generate a particle-injected air stream, the first nozzle to deliver the particle-injected air stream to a test chamber coupled to the first nozzle.

2. The apparatus of claim 1, wherein an outlet of the nozzle has an elliptical cross-section.

3. The apparatus of claim 1, wherein the injector includes a second nozzle and an angle of the second nozzle of the injector relative to the first nozzle is adjustable.

4. The apparatus of claim 3, wherein injector extends through an aperture formed in the particle dispersion chamber, the injector to one or more of slide through the aperture or rotate relative to the aperture to adjust the angle of the second nozzle.

5. The apparatus of claim 1, wherein the first nozzle includes a first portion and a second portion, the first portion including a converging portion and the second portion having an elliptical cross-section.

6. The apparatus of claim 5, wherein the second portion is formed from a first wall of the first nozzle and a second wall of the first nozzle, at least a portion of the first and second walls to diverge.

7. An apparatus comprising:
a test chamber, the test chamber having a first end and a second end opposite the first end;
a nozzle having an elliptical cross-section coupled to the first end;
an outlet at the second end; and
a rack disposed in the test chamber between the first end and the second end to position a test sample between the nozzle and the outlet, the nozzle to deliver an air flow including solid particles dispersed therein to the test chamber to expose the test sample to the air flow.

8. The apparatus of claim 7, wherein the test chamber further includes a vent at the first end, the vent to enable ambient air to enter the test chamber.

9. The apparatus of claim 7, wherein the nozzle is coupled to a particle dispersion chamber, the solid particles to mix with the air flow via the particle dispersion chamber.

10. The apparatus of claim 7, wherein the outlet is coupled to a particle collection chamber, the particle collection chamber to collect the solid particles dispersed in the air flow after the test sample is exposed to the air flow.

11. The apparatus of claim 10, wherein the outlet is coupled to the particle collection chamber via a duct, a portion of the outlet having a substantially square cross-section and the duct having a substantially circular cross-section.

12. The apparatus of claim 7, wherein the elliptical cross-section of the first nozzle has a major axis that is greater than a thickness of the test sample to enable the air flow to flow around a first side and an opposing second side of the test sample.

13. The apparatus of claim 7, wherein the rack is slidable relative to the test chamber to adjust a position of the test sample relative to the nozzle.

14. The apparatus of claim 13, wherein the rack includes rods that extend through the test sample, the rods enable the test sample to be positioned at different angles relative to a minor axis of the nozzle.

15. The apparatus of claim 7, further including a monitoring instrument coupled to the test chamber, the monitoring instrument to collect data during exposure of the test sample to the air flow.

16. An apparatus comprising:
a particle dispersion chamber;
a test chamber
means for providing air to particle dispersion chamber;
means for injecting particles into the particle dispersion chamber;
means for accelerating the particles relative to the air flow, the means for accelerating to deliver an air stream including the particles to means for testing a test sample.

17. The apparatus of claim 16, wherein the means for injecting particles includes one or more injectors, the one or more injectors at least partially disposed in the particle dispersion chamber.

18. The apparatus of claim 16, wherein the means for accelerating includes a nozzle having a converging portion and a diverging portion.

19. The apparatus of claim 18, wherein the diverging portion is to form an inlet of the test chamber.

20. The apparatus of claim 16, further including means for regulating pressure of one or more of the means for providing air and the means for providing for injecting particles.

21. The apparatus of claim 16, further including:
means for measuring a static pressure at the particle dispersion chamber;
means for measuring a static pressure at the test chamber; and
means for determining a velocity of the particles based on the static pressure measurement at the particle dispersion chamber and the static pressure measurement at the test chamber.
